(19) United States
(12) Patent Application Publication
(10) Pub. No.: US 2015/0169842 A1
(43) Pub. Date: Jun. 18, 2015

(54) METHOD AND APPARATUS

(71) Applicant: UNISENSE FERTILITECH A/S, Århus (DK)

(72) Inventors: Søren Porsgaard, Arhus (DK); Mette Lægdsmand, Viborg (DK); Inge Errebo Agerholm, Braedstrup (DK)

(21) Appl. No.: 14/407,067

(22) PCT Filed: Jun. 25, 2013
(86) PCT No.: PCT/EP2013/063240

§ 371 Date: Dec. 10, 2014

Related U.S. Application Data
(60) Provisional application No. 61/663,856, filed on Jun. 25, 2012.
(60) Provisional application No. 61/694,915, filed on Aug. 30, 2012.

(51) Int. Cl. G06F 19/00

(52) U.S. Cl. CPC G06F 19/3437

(57) ABSTRACT

Methods for determining a development potential for an embryo, for example an in vitro incubating human embryo, and apparatus for implementing such methods are described. In some examples a method comprises obtaining values for a plurality of morphokinetic characteristics relating to the development of an embryo during an observation period, for example characteristics relating to the temporal or morphological development of the embryo. A value for a continuous variable is determined by combining differences between the obtained values for these characteristics and corresponding reference values in a predefined manner. The reference values may, for example, be determined from values for the plurality of characteristics obtained for at least one reference embryo of known development potential. A development potential for the embryo is then established based on the determined value for the continuous variable.

### FIELD OF THE INVENTION

The present invention relates to methods and apparatus for determining the developmental potential of an embryo.

### BACKGROUND OF THE INVENTION

Infertility affects more than 80 million people worldwide. It is estimated that 10% of all couples experience primary or secondary infertility. Assisted Reproduction Treatment (ART) is an elective medical treatment that may provide a couple who has been otherwise unable to conceive a chance to establish a pregnancy. It is a process in which eggs (oocytes) are taken from a woman's ovaries and then fertilized with sperm in the laboratory. The embryos created in this process are then placed into the uterus for potential implantation. To avoid multiple pregnancies and multiple births, only a few embryos are transferred (normally less than four and ideally only one). Selecting the embryos for transfer is thus a critical step in any ART and retrospective analysis of ART outcome data is important for identifying improved embryo selection criteria.

Models for embryo selection can be constructed, evaluated and validated using Known Implantation Data (KID), whereby positive KID embryos are ones which are known to have subsequently implanted and negative KID embryos are ones which are known not to have subsequently implanted.

Models for embryo selection can also be constructed, evaluated and validated by observing if the embryo reached the blastocysts stage.

Current selection procedures are largely based on morphological evaluation of the embryo at different time points during development, and particularly an evaluation at the time of transfer using a standard stereomicroscope. However, there is a widely recognized desire to improve on known evaluation procedures.

One existing approach is to use ‘early cleavage’ to the 2-cell stage, (i.e. before 25-27 h post insemination/injection), as a quality indicator/selection criterion. In this approach the embryos are visually inspected 25-27 hours after fertilization to determine if the first cell cleavage has been completed.

Several studies have suggested the importance of the timings associated with cell divisions in determining embryo quality. In 2001, Lundin et al, for example, reported an early first cleavage as a strong indicator of embryo quality in human IVF (Lundin et al., 2001), and Meseguer et al reported the importance of several embryo morphological parameters on subsequent implantation of the embryo (Meseguer, et al., 2011).

A time-lapse system was used in Lemmen, et al., 2008 to study the timing and coordination of events during early development from zygote to cleavage state embryo. Early disappearance of pronuclei and onset of first cleavage after fertilization was correlated with a higher number of blastomeres on day 2 after oocyte retrieval. In addition, synchrony in appearance of nuclei after the first cleavage was associated with pregnancy success.

In recent years, time-lapse equipment has been used increasingly to incubate and monitor embryos during in vitro development. Time-lapse equipment is an instrument that takes photographs (microscope images) at time intervals (e.g. as often as every 5 minutes if desired) during incubation. This enables more precise timings of cell events during development to be readily established, e.g. timing of cell divisions, as compared to earlier approaches. This increased knowledge of the development of the embryo has potential for improving the selection of embryos (i.e. the process of identifying embryos with the greatest development potential/likelihood of successful implantation). Some examples of this approach can be found in WO 2012/163363 A1 (Unisense Fertilitech), WO 2013/004239 A1 (Unisense Fertilitech), WO 2011/025736 A1 (The Board of the Trustees of the Leland Stanford Junior University), U.S. Pat. No. 7,963,906 B2 (The Board of the Trustees of the Leland Stanford Junior University), and Wong et al., for example.

However, while early cleavage timing and other timings can help provide quality indicators for development of an embryo, there is still a need for methods and apparatus for better determining the development potential (viability/quality) of an embryo, such as an in vitro incubating human embryo.

### SUMMARY OF THE INVENTION

Existing techniques for establishing embryo quality from time-lapse microscope imaging are generally based on comparing the timing of a given embryo developmental event (such as the timing of a particular cell division stage) with a pre-defined range of timings previously seen to be associated with good quality embryos (e.g. based on an analysis of the timings for positive KID and negative KID embryos). If the timing of an embryo developmental event for a particular embryo falls within the pre-defined range of timings deemed to be associated with good-quality embryos, the embryo may be considered a good quality embryo. Conversely, if the timing of the embryo developmental event falls outside the pre-defined range of timings deemed to be associated with good-quality embryos, the embryo may be considered a poor quality embryo.

In this regard the identification of good-quality embryos (i.e. those having relatively high development potential) and poor-quality embryos (i.e. those having relatively low development potential) is based on a binary model. While such binary models are simple and robust, the present invention has been made through a recognition that these models provide for only relative coarse filtering of embryos. For example, existing binary models are unable to distinguish between different embryos that fall within the “good” range, and furthermore, these models are not readily amenable to the introduction of additional variables or taking account of variations in patient characteristics (such as age).

An approach in accordance with certain embodiments of the invention has been developed to facilitate the selection of optimal in vitro fertilized embryos to be transferred for implantation based on morphological and/or kinetic parameters extracted during their development. Thus, in accordance with certain embodiments the development potential of an embryo is established using a continuous model that takes account of a plurality of variables associated with the development of an embryo. This may be done by obtaining values for a plurality of characteristics relating to in vitro embryo development, for example using time-lapse microscope imaging. Values for the plurality of different characteristics may then be compared with reference values, for example by determining a difference from a corresponding average value determined for positive KID embryos, and combined together to generate one or more continuous variables. A developmental potential for the embryo may then be determined based on the value(s) of the continuous variable(s).

### STATEMENTS OF THE INVENTION

According to one aspect the present invention provides a method for determining a development potential for an embryo, the method comprising: obtaining values for a plurality of characteristics relating to the development of the embryo during an observation period; determining a value for a continuous variable by combining differences between the obtained values and corresponding reference values for the plurality of characteristics in a pre-defined manner; and establishing a development potential for the embryo based on the determined value for the continuous variable.

According to another aspect the present invention provides an apparatus for determining a development potential for an embryo, the apparatus comprising: a data input element configured to obtain values for a plurality of characteristics relating to the development of the embryo during an observation period; and a processor element for determining a value for a continuous variable by combining differences between the obtained values and corresponding reference values for the plurality of characteristics in a pre-defined manner and establishing a development potential for the embryo based on the determined value for the continuous variable.

### BRIEF DESCRIPTION OF THE DRAWINGS

For a better understanding of the invention and to show how the same may be carried into effect reference is now made by way of example to the accompanying drawings in which:

FIG. 1 schematically represents some nomenclature as used herein for a cleavage pattern showing cleavage times (t2 to t5), duration of cell cycles (cc1 to cc3), and synchronies (s2 and s3) in relation to images obtained.

FIG. 2 schematically represents embryo appearance at different embryo developmental events from initial fertilization (at time t=0) and at cleavage times t2-t8 and some associated aspects of timing terminology as used herein.

FIG. 3 schematically represents an apparatus for determining a development potential for an embryo in accordance with an embodiment of the invention.

FIG. 4 schematically plots cleavage time t2 against cleavage time t5 for a population of positive KID embryos (shown as plus symbols (+)) and negative KID embryos (shown as minus symbols (−)).

FIG. 5 schematically plots histograms of cleavage time t5 for populations of embryos from five different clinics.

FIG. 6 is a flow diagram schematically representing a method for determining a development potential for an embryo in accordance with some embodiments of the invention.

FIGS. 7A, 8A, 9A and 10A schematically plot different pairs of parameters determined in accordance with embodiments of the invention for a population of positive KID embryos (shown as plus symbols (+)) and negative KID embryos (shown as minus symbols (−)).

FIGS. 7B, 8B, 9B and 10B are magnified plots of the lower left corners of FIGS. 7B, 8B, 9B and 10B.

FIG. 11 schematically plots incidence rates for positive KID embryos and corresponding model predictions for four models determined in accordance with embodiments of the invention for a range of data percentiles.

### DETAILED DISCLOSURE OF THE INVENTION

Unless defined otherwise, all technical and scientific terms used herein have the same meaning as commonly understood by one of ordinary skill in the art to which this disclosure belongs. Singleton, et al., Dictionary of Microbiology and Molecular Biology, 20 Ed., John Wiley and Sons, New York (1994), and Hale & Marham, The Harper Collins Dictionary of Biology, Harper Perennial, NY (1991) provide one of skill with a general dictionary of many of the terms used in this disclosure.

This disclosure is not limited by the exemplary methods and materials disclosed herein, and any methods and materials similar or equivalent to those described herein can be used in the practice or testing of embodiments of this disclosure.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within this disclosure. The upper and lower limits of these smaller ranges may independently be included or excluded in the range, and each range where either, neither or both limits are included in the smaller ranges is also encompassed within this disclosure, subject to any specifically excluded limit in the stated range. Where the stated range includes one or both of the limits, ranges excluding either or both of those included limits are also included in this disclosure.

It must be noted that as used herein and in the appended claims, the singular forms “a”, “an”, and “the” include plural referents unless the context clearly dictates otherwise. Thus, for example, reference to “an embryo” includes a plurality of such candidate embryos, and so forth.

The publications discussed herein are provided solely for their disclosure prior to the filing date of the present application. Nothing herein is to be construed as an admission that such publications constitute prior art to the claims appended hereto.

All patent and non-patent references cited in are also hereby incorporated by reference in their entirety.

Some example embodiments of the present invention relate to a method for determining a development potential for an embryo, the method comprising: obtaining values for a plurality of characteristics relating to the development of the embryo during an observation period; determining a value for a continuous variable by combining differences between the obtained values and corresponding reference values for the plurality of characteristics in a pre-defined manner; and establishing a development potential for the embryo based on the determined value for the continuous variable.

In accordance with some example embodiments the reference values are determined from values for the plurality of characteristics obtained for at least one reference embryo of known development potential.

In accordance with some example embodiments the step of combining differences between the obtained values and the reference values takes account of weighting values associated with each of the reference values.

In accordance with some example embodiments the weighting values are statistically determined from values for the plurality of characteristics obtained for a plurality of reference embryos of known development potential.

In accordance with some example embodiments the weighting values are determined from a variance of the values obtained for the plurality of reference embryos.

In accordance with some example embodiments the plurality of characteristics relate to morphological developments of the embryo.

In accordance with some example embodiments the continuous variable represents a measure of regularity in the morphological developments of the embryo.

In accordance with some example embodiments the plurality of characteristics relate to temporal developments of the embryo.

In accordance with some example embodiments the continuous variable represents a measure of regularity in the temporal developments of the embryo.

In accordance with some example embodiments the plurality of characteristics comprise a plurality of cell cycle durations for the embryo, cci.

In accordance with some example embodiments the plurality of characteristics comprise a plurality of differences in time between subsequent cell divisions for the embryo, Δtj.

Some example embodiments of the present invention further comprise: obtaining values for a further plurality of characteristics relating to the development of the embryo during the observation period; determining a value for a further continuous variable by combining differences between the obtained values and corresponding reference values for the further plurality of characteristics in a further pre-defined manner; and establishing the development potential for the embryo based also on the determined value for the further continuous variable.

In accordance with some example embodiments the values are obtained by time-lapse microscopy.

Some example embodiments of the present invention relate to an apparatus for determining a development potential for an embryo, the apparatus comprising: a data input element configured to obtain values for a plurality of characteristics relating to the development of the embryo during an observation period; and a processor element for determining a value for a continuous variable by combining differences between the obtained values and corresponding reference values for the plurality of characteristics in a pre-defined manner and establishing a development potential for the embryo based on the determined value for the continuous variable.

Some example embodiments of the present invention relate to a non-transitory computer program product bearing machine readable instructions for carrying out methods according to other example embodiments of the invention.

Some example embodiments of the present invention relate to an apparatus loaded with and operable to execute machine readable instructions for carrying out methods according to other example embodiments of the invention.

Various terms may be used herein in accordance with the following definitions (unless the context demands another meaning).

Cleavage time is defined as the first observed timepoint when newly formed blastomeres are completely separated by confluent cell membranes, the cleavage time is therefore the time of completion of a blastomere cleavage. In the present context the times are usually expressed as hours post IntraCytoplasmic Sperm Injection (ICSI) microinjection, i.e. the time of fertilization (the successful fusion of gametes to form a new organism; the zygote). Thereby the cleavage times are as follows:
t2: Time of cleavage to 2 blastomere embryo
t3: Time of cleavage to 3 blastomere embryo
t4: Time of cleavage to 4 blastomere embryo
t5: Time of cleavage to 5 blastomere embryo
t6: Time of cleavage to 6 blastomere embryo
t7: Time of cleavage to 7 blastomere embryo
t8: Time of cleavage to 8 blastomere embryo
tn: Time of cleavage to n blastomere embryo

The first cell cycle duration cc1 is the period between fertilisation and the cleavage time t2 that provides the first pair of daughter cells (i.e. the first second-generation cells). The second cell cycle duration cc2 is the period between the cleavage time t2 that provides the first pair of daughter cells and the cleavage time t3 that provides the first pair of granddaughter cells (i.e. the first third-generation cells). The third cell cycle duration cc3 is the period between the cleavage time t3 that provides the first pair of granddaughter cells and the cleavage time t5 that provides the first pair of great-granddaughter cells (i.e. the first fourth-generation cells). The fourth cell cycle duration cc4 is the period between the cleavage time t5 that provides the first pair of great-granddaughter cells and the cleavage time t9 that provides the first pair of great-great-granddaughter cells (i.e. the first fifth-generation cells).

These cell cycle durations are thus based on the fastest of the blastomeres to divide for each new generation. However, there are additional cell cycle durations associated with division of slower blastomeres.

For example, in addition to cell cycle duration cc2 there is a cell cycle duration cc2b corresponding to the period between the cleavage time t2 that provides the first pair of daughter cells and the cleavage time t4 that provides the second pair of granddaughter cells. In this regard cell cycle duration cc2 may also be referred to as cell cycle duration cc2a for simplicity in terminology.

Furthermore, in addition to cell cycle duration cc3 there is a cell cycle duration cc3b corresponding to the period between the cleavage time t3 that provides the first pair of granddaughter cells and the cleavage time t6 that provides the second pair of great-granddaughter cells. There is also a cell cycle duration cc3c corresponding to the period between the cleavage time t4 that provides the second pair of granddaughter cells and the cleavage time t7 that provides the third pair of great-granddaughter cells. There is also a cell cycle duration cc3d corresponding to the period between the cleavage time t4 that provides the second pair of granddaughter cells and the cleavage time t8 that provides the fourth pair of great-granddaughter cells. In this regard cell cycle duration cc3 may also be referred to as cell cycle duration cc3a for consistency in terminology.

Thus, duration of cell cycles is defined as follows:
cc1=t2: First cell cycle.
cc2 (also referred to cc2a)=t3−t2: Second cell cycle, duration of period as 2 blastomere embryo.
cc2b=t4−t2: Second cell cycle for both blastomeres, duration of period as 2 and 3 blastomere embryo.
cc3 (also referred to cc3a)=t5−t3: Third cell cycle, duration of period as 3 and 4 blastomere embryo.
cc2_{—}3=t5−t2: Second and third cell cycle, duration of period as 2, 3 and 4 blastomere embryo (i.e. cc2+cc3).
cc4=t9−t5: Fourth cell cycle, duration of period as 5, 6, 7 and 8 blastomere embryo.

Synchronicities are defined as follows:
s2=t4−t3: Synchrony in division from 2 blastomere embryo to 4 blastomere embryo.
s3=t8−t5: Synchrony in division from 4 blastomere embryo to 8 blastomere embryo.
s3a=t6−t5; s3b=t7−t6; s3c=t8−t7: Duration of the individual cell divisions involved in the development from 4 blastomere embryo to 8 blastomere embryo.
cc3b, cc3c, cc3d=t6−t3; t7−t4; and t8−t4 respectively: Third cell cycle for slower blastomeres, duration of period as a 3, 4, and 5 blastomere embryo; as a 4, 5 and 6 blastomere embryo, and as a 4, 5, 6 and 7 blastomere embryo respectively.

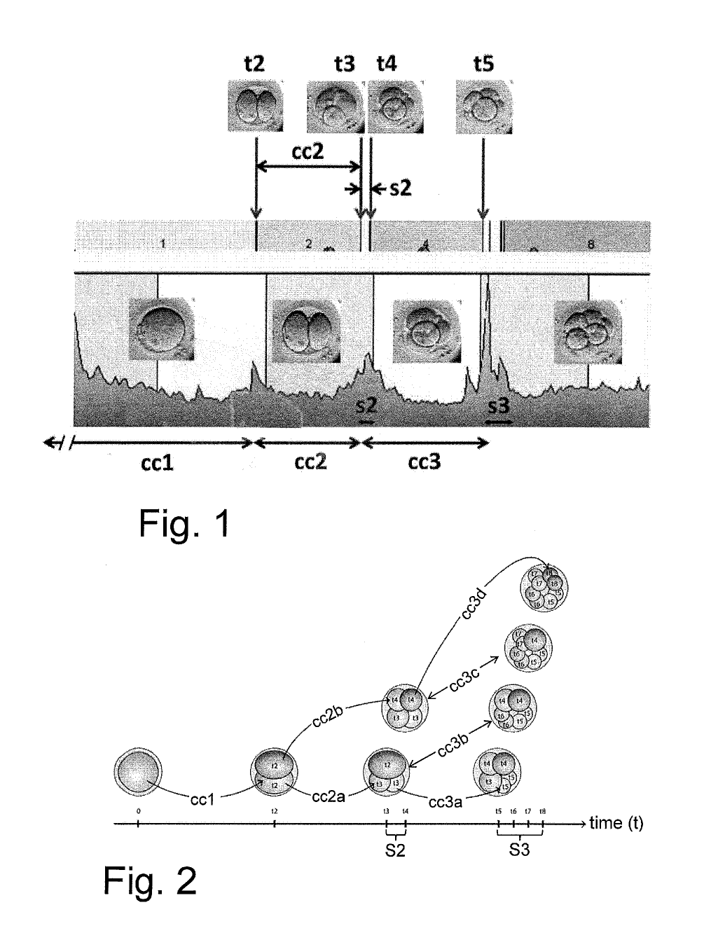

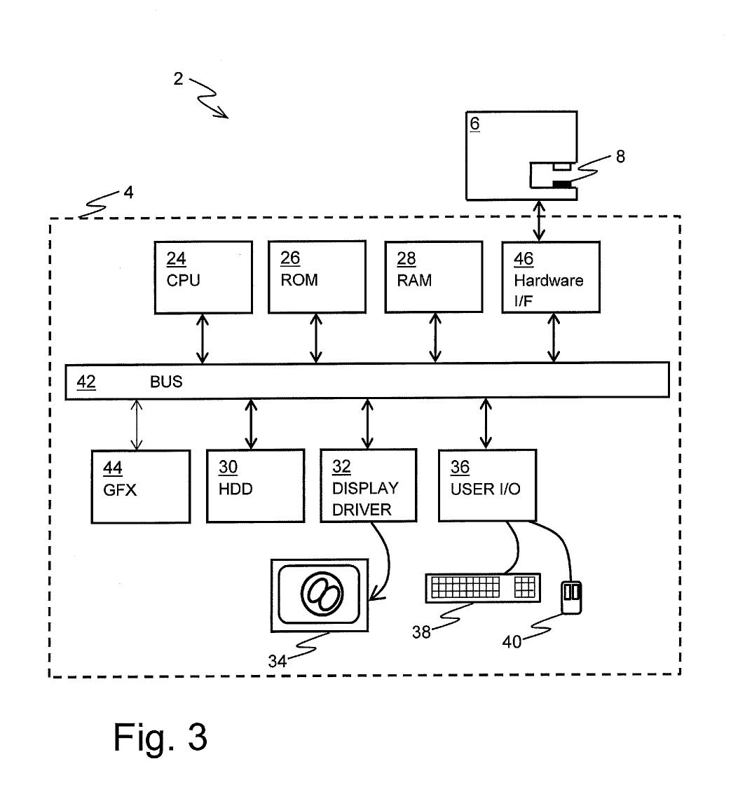

FIGS. 1 and 2 schematically represent some aspects of the terminology used herein regarding the timings and durations of some embryo developmental events such as discussed above. FIG. 1 shows a number of images of an embryo at various stages of development and indicates various timings associated with various developmental events, such as t2, t3, t4, t5, cc1, cc2 (which may also be referred to herein as cc2a), cc3 (which may also be referred to herein as cc3a), s2 and s3. FIG. 2 schematically represents from left to right the development of the embryo through the one, two, three, four, five, six, seven and eight blastomere stages. The times t2 to t8 at which the respective cell division stage are complete is schematically marked along the bottom axis. FIG. 2 also schematically indicates the cell cycle durations cc1, cc2a, cc2b, cc3a, cc3b, cc3c and cc3d and synchronicities S2 and S3.

Cleavage period is defined as the period of time from the first observation of indentations in the cell membrane (indicating onset of cytoplasmic cleavage) to when the cytoplasmic cell cleavage is complete so that the blastomeres are completely separated by confluent cell membranes. Also termed as duration of cytokinesis.

Fertilization and cleavage are the primary morphological events of an embryo, at least until the 8 blastomere stage. Cleavage time, cell cycle, synchrony of division and cleavage period are examples of morphological embryo parameters that can be defined from these primary morphological events and each of these morphological embryo parameters are defined as the duration of a time period between two morphological events, e.g. measured in hours.

A normalized morphological embryo parameter is defined as the ratio of two morphological embryo parameters, e.g. cc2 divided by cc3 (cc2/cc3), or cc2/cc2_{—}3 or cc3/t5 or s2/cc2.

The duration of a plurality of cell cycles (e.g. CC1, CC2, CC3 and CC4) can be combined to form a common normalized parameter:

$${CC}_{norm} = \sqrt{{\sum }_{alli}^{ } {( \frac{CCi - {CCi}_{median}}{{CCi}_{median}} )}^{2}}$$

where CCi e.g. is selected from CC1 to CC4. In one embodiment of the invention a high value of CCₙₒᵣₘ indicates a poor embryo quality as one or more of the variables CCi is far from the median, i.e. it is not the absolute values of CCi that are used, but the mutual relation of the variables. The median may be calculated based on the whole population or parts of the population (e.g. embryos with known and positive implantation). Another equivalent variable using the logarithmic value instead ICCₙₒᵣₘ) may also be useful in assessing embryo quality.

$${lCC}_{norm} = \sqrt{{\sum }_{alli}^{ } {w}_{i} {log ( \frac{CCi - {CCi}_{median}}{{CCi}_{median}} )}^{2}}$$

Likewise the synchronicity Si of the cell divisions (e.g. S2, S3 and S4) may be combined to form a common normalized parameter:

$${S}_{norm} = \sqrt{{\sum }_{alli}^{ } {( \frac{Si}{{Si}_{median}} )}^{2}}$$

In one embodiment of the invention a high value of Sₙₒᵣₘ indicates a poor embryo quality as one or more of the synchronicities is long compared to the. Another equivalent variable using the logarithmic value instead (ISₙₒᵣₘ) may also be useful in assessing embryo quality.

$${lS}_{norm} = \sqrt{{\sum }_{alli}^{ } {w}_{i} {log ( \frac{Si}{{Si}_{median}} )}^{2}}$$

The variables CCₙₒᵣₘ and Sₙₒᵣₘ may be calculated based on the first, second, third or fourth cell cycle, depending on the duration of the incubation.

The following discrete (binary) variables can be used
MN2: Multi nucleation observed at the 2 blastomere stage; can take the values “True” or False”.
MN2val: the number of multinuclear cells at the 2 cell stage (0,1,2).
MN4: Multi nucleation observed at the 4 blastomere stage; can take the values “True” or False”.
MN4val: the number of multinuclear cells at the 4 cell stage (0,1,2,3,4).
EV2: Evenness of the blastomeres in the 2 blastomere embryo; can take the values “True” (i.e. even) or “False” (i.e. uneven).

WO 2013/004239 A1 (Unisense Fertilitech) entitled “Adaptive embryo selection criteria optimized through iterative customization and collaboration” relates to the issue of adapting embryo quality criteria across populations of embryos cultures under different incubation conditions, e.g. in different clinics. This application is hereby incorporated by reference in its entirety. However, quality parameters like CCₙₒᵣₘ, ICCₙₒᵣₘ, Sₙₒᵣₘ and ISₙₒᵣₘ may help to ensure that quality models will be directly applicable across different populations of embryos cultured under different incubation conditions, because they are based on variables that are insensitive to differences in running conditions. Another example of that is quality parameters based on relative time periods (e.g. cc2/cc3), variables divided with a central estimate of that variable (e.g. mean or median, e.g. cc2/cc2_median) or using target intervals where the center is scaled according to a central estimate and the boundaries are scaled according to a variance estimate (e.g. variance, standard deviation, percentiles).

Embryo quality is a measure of the ability of an embryo to successfully implant and develop in the uterus after transfer. Embryos of high quality have a higher probability of successfully implanting and developing in the uterus after transfer than low quality embryos. However, even a high quality embryo is not a guarantee for implantation as the actual transfer and the woman's receptivity influences the final result.

Viability and quality are used interchangeably in this document. Embryo quality (or viability) measurement is a parameter intended to reflect the quality (or viability) of an embryo such that embryos with certain values of the quality parameter (e.g. high or low values depending on how the parameter is defined) have a high probability of being of high quality (or viability), and low probability of being low quality (or viability). Whereas embryos with certain other values for the quality (or viability) parameter have a low probability of having a high quality (or viability) and a high probability of being low quality (or viability)

The term “developmental potential” as defined herein means the likelihood of an embryo to develop to blastocyst stage, to implant, to result in pregnancy, and/or to result in a live-born baby. In some embodiments the development potential may be a determination of embryo quality. Developmental potential may be equated with embryo quality. Embryo quality (or the developmental potential of an embryo) may be based on the information obtainable from observations on the developing embryo and the fate of it. A positive developmental potential (or good (or high) embryo quality) results in development of the embryo to blastocyst stage, results in successful implantation, development of the embryo in the uterus after transfer, results in pregnancy, and/or results in live-born babies (preferably at least results in successful implantation). A negative developmental potential (or poor embryo quality) results in the embryo arresting before development to blastocyst stage, non-implantation and miscarriage. It is preferred to use non-invasive methods such as morphological characteristics in determining embryo quality.

Embryos of good (or high) quality have a higher probability of successfully implanting and/or of developing in the uterus after transfer compared with low quality embryos. However, even a high quality embryo is not a guarantee for implantation as the actual transfer and the woman's receptivity highly influences the final result.

As noted above, in accordance with some embodiments a value for a continuous variable is determined from a plurality of characteristics relating to the development of the embryo during an observation period. The variable value may then be used to establish a developmental potential of the embryo.

In some cases the term “embryo” is used to describe a fertilized oocyte after implantation in the uterus until 8 weeks after fertilization at which stage it become a fetus. According to this definition the fertilized oocyte is often called a pre-embryo or zygote until implantation occurs. However, the term “embryo” as used herein will have a broader definition, which includes the pre-embryo phase. The term “embryo” as used herein encompasses all developmental stages from the fertilization of the oocyte through morula, blastocyst stages, hatching and implantation.

An embryo is approximately spherical and is composed of one or more cells (blastomeres) surrounded by a gelatine-like shell, the acellular matrix known as the zona pellucida. The zona pellucida performs a variety of functions until the embryo hatches, and is a good landmark for embryo evaluation. The zona pellucida is spherical and translucent, and should be clearly distinguishable from cellular debris.

An embryo is formed when an oocyte is fertilized by fusion or injection of a sperm cell (spermatozoa). The term embryo is traditionally used also after hatching (i.e. rupture of zona pellucida) and the ensuing implantation. For humans the fertilized oocyte is traditionally called a zygote or an embryo for the first 8 weeks. After that (i.e. after eight weeks and when all major organs have been formed) it is called a fetus. However the distinction between zygote, embryo and fetus is not generally well defined. The terms embryo and zygote are used herein interchangeably.

An embryo evaluated in the present method may be previously frozen, e.g. embryos cryopreserved immediately after fertilization (e.g. at the 1-cell stage) and then thawed. Alternatively, they may be freshly prepared, e.g. embryos that are freshly prepared from oocytes by IVF or ICSI techniques for example.

Fertilization is the time point where the sperm cell is recognized and accepted by the oocyte. The sperm cell triggers egg activation after the meiotic cycle of the oocyte has been suspended in metaphase of the second meiotic division. This results in the production and extrusion of the second polar body. Some hours after fusion of sperm and ovum, DNA synthesis begins. Male and female pronuclei (PN) appear. The PN move to the center of the egg and the membranes breakdown and the PN disappear (fade). This combination of the two genomes is called syngamy. Hereafter, the cell divisions begin.

The time when the pronuclei disappear may be referred to as t2PN. The terms “fade(d)” and “disappear(ed)” in relation to the pro-nuclei (PN) may be used herein interchangeably.

During embryonic development, blastomere numbers increase geometrically (1-2-4-8-16- etc.). Synchronous cell cleavage is generally maintained to the 8-cell stage in human embryos. After that, cell cleavage becomes asynchronous and finally individual cells possess their own cell cycle. Human embryos produced during infertility treatment can be transferred to the recipient before 8-blastomere stage. In some cases human embryos are also cultivated to the blastocyst stage before transfer. This is preferably done when many good quality embryos are available or prolonged incubation is necessary to await the result of a pre-implantation genetic diagnosis (PGD). However, there is a tendency towards prolonged incubation as the incubation technology improves.

Accordingly, the term embryo is used in the following to denote each of the stages fertilized oocyte, zygote, 2-cell, 4-cell, 8-cell, 16-cell, compaction, morula, blastocyst, expanded blastocyst and hatched blastocyst, as well as all stages in between (e.g. 3-cell or 5-cell).

Some example implementations of embodiments of the invention may use blastocyst related parameters.

A blastocyst quality criterion is an example of an embryo quality criterion. The blastocyst quality criteria may, for example, relate to the development of the embryo from compaction, i.e. initial compaction, to the hatched blastocyst. Compaction is a process wherein an intensification of the contacts between the blastomeres with tight junction and desmosomes result in reduction of the intercellular space and a blurring of the cell contours. Before compaction the blastomeres of the embryo can be followed individually and before compaction the embryo development follow a route of distinct and mostly synchronous cell divisions that can be observed by the naked eye and readily annotated. After compaction the embryo development is characterized by a more or less continuous development from morula to blastocyst, where individual blastomeres become difficult to track, but a number of stages may nonetheless be characterised in accordance with established techniques, e.g. visually, and can be annotated (identified) to provide blastocyst related parameters. The following blastocyst related parameters may be used in some example implementations:

Start of compaction (SC) describes the first time a compaction between 2 or more blastomeres is observed. Thus, SC marks the initiation of the compaction process. Morula (M) is defined as the first time where no plasma-membranes between any blastomeres are visible. When the compaction process is complete no plasma-membranes between any of the blastomeres forming the compaction are visible and the embryo can be defined as a morula. Most often Morula is seen after S3 close to or right in the beginning of the fourth synchrony period (S4). Rarely do the embryos cleave to 16 cell or more before compaction is initiated.

Initial differentiation of trophectoderm (IDT) is defined as the first time during the morula stage where distinct trophectoderm cells are recognized. It describes the onset of differentiation of the trophectoderm cells. The blastomeres gradually become flattened and elongate creating a barrier between the outside environment and the inner cell part of the morula.

Start of blastulation (SB) is defined as the first time a fluid-filled cavity, the blastocoel, can be observed. It is also referred to as “Onset of cavitation”. It describes the initiation of the transition period between the morula stage and the blastocyst stage of the embryo. Embryos often remain in this transition stage for a period of time before entering the actual blastocyst stage. The onset of cavitation usually appears immediately after differentiation of the trophectoderm cells. The outer layer of the morula with contact to the outside environment begins to actively pump salt and water into the intercellular space, as a result of which a cavity (the blastocoel) begins to form.

Blastocyst (B) is defined as where the fluid filled cavity is finally formed, i.e. the cavity does not increase significantly anymore before the blastocyst starts to expand

Initial differentiation of inner cell mass (IDICM) defined as the first time the inner cell mass can be recognized. IDICM describes the initiation of inner cell mass development. An eccentrically placed cluster of cell connected of gab junction where the boundaries between the cells seem not well defined.

Onset of expansion of the blastocyst (EB) is defined as the first time the embryo has filled out the periviteline space and starts moving/expanding Zona Pelucidae. EB describes the initiation of the embryos expansion. As the blastocyst expands the zona pellucida becomes visibly thinner.

Hatching blastocyst (HB) is defined as the first time a trophectoderm cell has escaped/penetrated the zona pellucida.

Fully hatched blastocyst (FH) is defined as when hatching is completed with shedding zona pellucida.

Various timings associated with blastocyst development may be defined as follows:

tM=Time from insemination to formation of morula (hours)

tSB=Time from insemination to start of blastulation (hours)

tB=Time from insemination to formation of blastocyst (hours)

tEB=Time from insemination to formation of expanded blastocyst (hours)

tHB=Time from insemination to hatching blastocyst (hours)

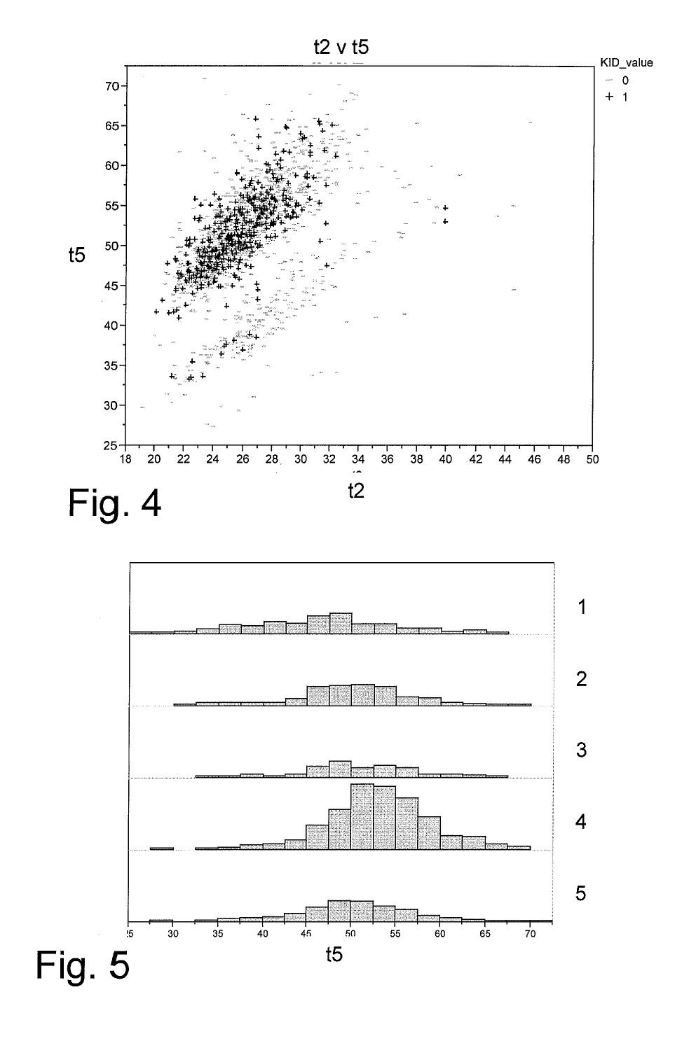

FIG. 3 schematically represents an apparatus 2 for determining a development potential for an embryo 8 in accordance with certain embodiments of the invention. The apparatus 2 comprises a general purpose computer 4 coupled to an embryo imaging system 6. The embryo imaging system 6 may be generally conventional and is configured to obtain images of the embryo 8 at various stages of development in accordance with established techniques. It will be appreciated that in general the embryo imaging system 6 will typically be configured to obtain images of a plurality of embryos, rather than just a single embryo, over a monitoring period. For example, a typical study may involve the analysis of a number of embryos, for example 72 embryos. The embryo imaging system may be configured to record images of each embryo (potentially with images of being taken in multiple focal planes) one at a time before moving on to image the next embryo. Once all embryos have been imaged, which might, for example, take 5 minutes, the cycle of imaging the individual embryos may be repeated to provide respective images for the respective embryos for the next time point.

The general purpose computer 4 is adapted (programmed) to execute a method for determining a development potential of an embryo from an analysis of images obtained from the embryo imaging system 6 as described further below.

Thus the computer system 4 is configured to perform processing of embryo image data in accordance with an embodiment of the invention. The computer 4 includes a central processing unit (CPU) 24, a read only memory (ROM) 26, a random access memory (RAM) 28, a hard disk drive 30, a hardware interface 46, a display driver 32 and display 34 and a user input/output (IO) circuit 36 with a keyboard 38 and mouse 40. These devices are connected via a common bus 42. The computer 4 also includes a graphics card 44 connected via the common bus 42. The graphics card includes a graphics processing unit (GPU) and random access memory tightly coupled to the GPU (GPU memory). The embryo imaging system 6 is communicatively coupled to the computer 4 via the hardware interface 46 in accordance with conventional technical techniques.

The CPU 24 may execute program instructions stored within the ROM 26, the RAM 28 or the hard disk drive 30 to carry out processing of embryo image data that may be stored within the RAM 28 or the hard disk drive 30. The RAM 28 and hard disk drive 30 are collectively referred to as the system memory. In some implementations, processing in accordance with embodiments of the invention may be based on embryo images obtained by the computer 4 directly from the imaging system 6. In other implementations, processing in accordance with embodiments of the invention may be based on embryo images previously obtained and stored in a memory of the computer 4, e.g. in RAM 28 of HDD 30 (i.e. the embryo imaging system 6 itself is not a required element of embodiments of the invention). Aspects of the computer 4 may largely be conventional except that the CPU is configured to run a program, which may for example be stored in RAM 28, ROM 26 or HDD 30, to perform processing in accordance with certain embodiments of the invention as described herein.

The embryo 8 in accordance with certain example implementations is monitored regularly using the embryo imaging system 6 to obtain the relevant information (i.e. timings associated with particular embryo developmental events). The embryo is preferably monitored at least once per hour, such as at least twice per hour, such as at least three times per hour, such as at least four times per hour, such as at least six times per hour, such as at least 12 times per hour. The monitoring is preferably conducted while the embryo is situated in an incubator used for culturing the embryo. This is preferably carried out through image acquisition of the embryo, such as discussed herein in relation to time-lapse methods.

Determination of selection criteria (from timings of developmental events as described herein) can be done, for example, by visual inspection of the images of the embryo 8 and/or by automated methods such as described in detail in WO 2007/042044 A1 (Unisense Fertilitech) entitled “Determination of a change in a cell population”. Furthermore, other methods to determine selection criteria can be done by determining the position of the cytoplasm membrane by envisioned e.g. by using FertiMorph software (ImageHouse Medicall Copenhagen, Denmark). The described methods can be used alone or in combination with visual inspection of the images of the embryo and/or with automated methods as described above.

As noted above, certain implementations of methods according to examples of the present invention may be preferably carried out and/or the values measured by time-lapse microscopy. A suitable system for measuring the values by time-lapse microscopy is described in WO2007/042044 A1 (which is incorporated herein by reference). The resulting different images can be used to quantify the amount of change occurring between consecutive frames in an image series.

The invention may be applied to analysis of difference image data, where the changing positions of the cell boundaries (i.e. cell membranes) as a consequence of cellular movement causes a range parameters derived from the difference image to rise temporarily (see WO 2007/042044 A1). These parameters include (but are not restricted to) a rise in the mean absolute intensity or variance. One example of such a parameter is plotted in FIG. 1 ad shows “spikes” associated with the occurrence of various developmental events. Cell cleavages and their duration and related cellular re-arrangement can thus be detected by temporary change, an increase or a decrease, in standard deviation for all pixels in the difference image or any other of the derived parameters for “blastomere activity” listed in WO 2007/042044. However the selection criteria may also be applied to visual observations and analysis of time-lapse images and other temporally resolved data (e.g. excretion or uptake of metabolites, changes in physical or chemical appearance, diffraction, scatter, absorption etc.) related to the embryo.

In a general sense, various methods described herein in accordance with certain embodiments of the invention are based on determining a developmental potential for an embryo from timings associated with various embryo developmental events, such as cleavage times and/or cell cycle durations. In this regard the specific manner by which the various timings are obtained is not of primary significance. Indeed, the timings may be obtained in accordance with any conventional techniques, for example using images obtained using a conventional time-lapse embryo imaging system 6 such as schematically represented in FIG. 3. For example, in accordance with one approach a user may review time-lapse images of a developing embryo and record when the relevant embryonic development event occurs (for example a particular cell division). Typically a user might “play” a video sequence comprising the time-lapse images of an embryo, and “pause” the playback (or simply “click” during ongoing playback) when a relevant cell division is observed to take place. The time of the “pause” or “click” may then be recorded as corresponding to the timing of the associated developmental event. This may be referred to as manual. Identification of timings. The identification of a particular timing for a given event may sometimes be referred to as annotating the event. Thus, an embryonic developmental event for which a timing is established, for example using manual identification techniques, may sometimes be referred to as an annotated event.

As noted above it is known to consider certain variables associated with embryo development when seeking to find a model for predicting which embryos have good development potential. By way of an example of this approach, variables corresponding to the cleavage times t2 and t5, as defined above, may be considered.

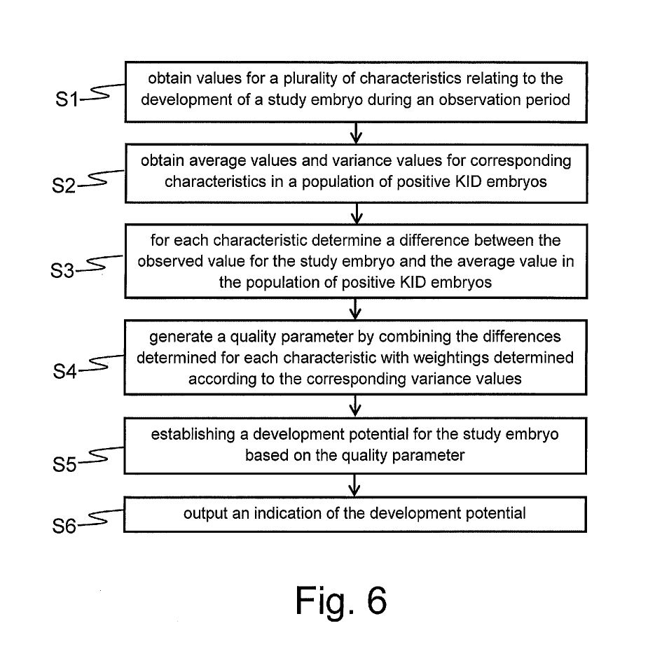

FIG. 4 schematically plots cleavage time t5 against cleavage time t2 for a population of positive KID embryos (shown as plus-symbols (+) and negative KID embryos (shown as minus-symbols (−)) based on KID data obtained from five different clinics. From this plot it is, however, difficult to estimate the optimal combination of the parameters t5 and t2 because the positive KID observations (plus symbols) and the negative KID observations (minus symbols) overlap to a significant extent.

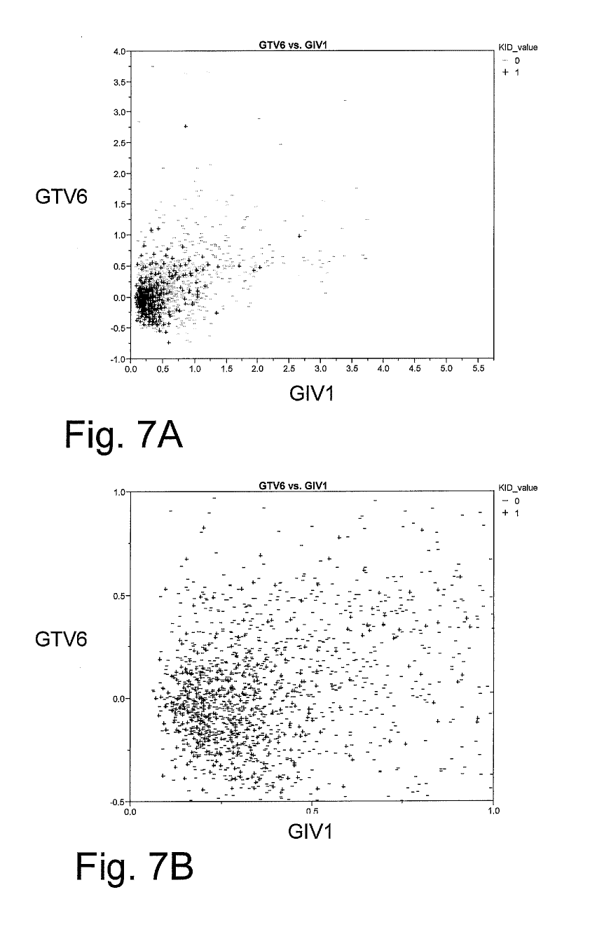

A further issue relating to the use of simple cleavage times for embryo assessment identified by the inventors is that variations in cleavage time can arise under different incubation conditions. This is schematically represented in FIG. 5 which plots histograms of values for cleavage time t5 seen in data from five different clinics (labeled 1 to 5 in the figure). The different clinics have different incubation conditions, for example in terms of temperature, oxygen presence, and so forth, and these can lead to faster or slower morphokinetic embryo development. For example, it is apparent from FIG. 5 that the incubation conditions for clinic 1 typically result in lower values for t5 than the incubation conditions for clinic 4. This can mean the determined optimum values for embryo developmental events for embryos incubated at one clinic can be different from the determined optimum values for the same embryo developmental events for embryos incubated at a different clinic. This can make it difficult to establish a model for establishing embryo developmental potential that is applicable to embryos from different clinics (i.e. embryos subject to different incubation conditions).

To help reduce the impact of some of the issues discussed above, certain embodiments of the invention provide for deriving what might be termed aggregated variables from a plurality of timings associated with embryo developmental events. The timings themselves may be established in accordance with conventional techniques. One or more of such aggregated variables is then used to provide an indicator for the development potential of an embryo.

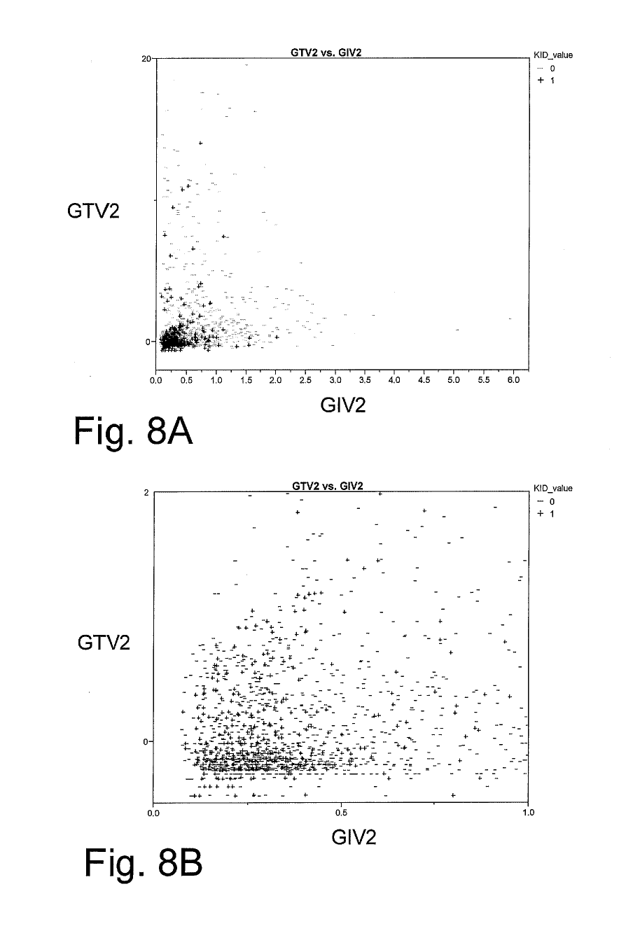

FIG. 6 is a flow diagram that schematically represents a method for determining the development potential of an embryo (referred to here as a study embryo) in accordance with an embodiment of the invention. The method may, for example, be implemented by the general purpose computer represented in FIG. 3. In particular, the method may be implemented by a processing unit, such as the CPU 24, running a program for causing the computer to execute the method. In a general sense, embodiments of the invention according to the method schematically represented in FIG. 6 are directed to generating a value for a continuous variable from a plurality of characteristics relating to the development of the study embryo.

In step S1 a plurality of characteristics relating to the development of the study embryo during an observation period are obtained. These characteristics may fundamentally be based on cleavage times determined using conventional time-lapse embryonic imaging. One or more characteristics may be based on the timing of pronuclei fading/disappearance (tPNfading (or tPNf)).

In this example the characteristics comprise a series of cell cycle durations cci for a sequence of cell cycles. For example, the plurality of characteristics may comprise a series of values: cc2a (=t3−t2); cc2b (=t4−t2); cc3a (=t5−t3), cc3b (=t6−t3), cc3c (=t7−t4), cc3d (=t8−t4). That is to say, for this example the sequence comprises durations for all cell cycles from cc2a to cc3d (i.e. all cell cycle durations up to an eight-blastomere embryo except for cc1). If there are particular cell cycle durations that are not measured for a given embryo (e.g. because the timing of a relevant cleavage event cannot be properly determined because of inadequate measurement or because the cleavage event has not occurred by the end of the indication time (tEnd)), the missing cell cycle(s) may be left out of the sequence. The characteristics may be obtained through a data input unit of an apparatus performing the method. The data input unit may thus comprise an element of a computer configured to read data from a memory or from an embryo imaging system, for example. The data may comprise already-determined values for the characteristics, or may contain information, such as cell cleavage times or microscope images, from which the characteristics may be derived. Cell cleavage times may be established, for example, based on previous manual annotation of the data.

In step S2 average and variance values seen in a population of positive KID embryos for characteristics corresponding to those obtained for the study embryo in step S1 are obtained. These may, for example, be read from a memory or other storage of an apparatus executing the method. The average and variance values may be obtained through retrospective analysis of images of embryos that proceeded to successful implantation. The embryos for which the average and variance values are obtained for a given study embryo may be referred to as reference embryos. The reference embryos may in some cases comprise embryos that have been expected at the same clinic as the study embryo, for example to help take account of inter-clinic variations associated with different incubation conditions. That is to say, step S2 may also comprise selecting an appropriate grouping of reference embryos for which to obtain the average and variance values based on Risks of the study embryo. The average and variance values may be determined in accordance with conventional statistical analysis techniques, for example potentially involving the discarding of outlier data, and so forth. It will be appreciated the term “average” is used broadly herein to refer to a typical/representative/indicative value for a parameter seen in a sample population. In this regard, the average may, for example, correspond to a mean, mode or median value of the relevant characteristic for the reference population (positive KID population).

In step S3 a difference between the value of each characteristic seen for the study embryo and the corresponding average characteristic associated with the population of positive KID embryos is determined.

In step S4 a quality parameter for the study embryo (corresponding to a continuous variable) is determined by combining/aggregating the differences determined for each characteristic in a way which is weighted by the respective variance values. Thus in one specific example, a quality parameter (GIV) is defined as:

$$GIV = \frac{1}{n} \sqrt{{\sum }_{all i i n \\ sequence}^{ } \frac{{( cci - {cci}_{m} )}^{2}}{{cci}_{v}}} \qquad [ 1 ]$$

Where cci is the series of cell cycle durations observed for the study embryo, cciₘ is the corresponding series of average cell cycle durations seen in a reference group of embryos (e.g. the positive KID population from patients under the age 35), and cciᵥ are the corresponding variance values associated with the reference population. The parameter n is the number of cell cycle durations comprising the series cci. The differences (cci−cciₘ) are normalized by the variance values cciᵥ as part of the combining. This means that differences for particular cell cycles (values of i) which exhibit relatively high variance in the sample population contribute less to the value of GIV than differences for cell cycle which exhibit relatively low variance in the sample population. The differences (cci−cciₘ) are squared in the combining, and this means the contribution to GIV is the same for a given difference, regardless of whether it is positive or negative (i.e. whether cci is longer or shorter than cciₘ).

Generally speaking GIV is low when the study embryo exhibits a regular cleavage pattern and is high when the embryo exhibits an irregular cleavage pattern.

The particular quality parameter based on the particular sequence of cell cycle durations cci=cc2a; cc2b; cc3a; cc3b; cc3c and cc3d in this example may be referred to herein as a first generalized irregularity variable GIV1.

In step S5 a development potential for the study embryo is established based on the quality parameter (GIV1 in this example). This process is discussed generally further below. In step S6 an indication of the established development potential for the embryo is output, for example on a display presented to a clinician.

Thus, FIG. 6 schematically represents a process for establishing a development potential for an embryo in accordance with an embodiment of the invention. It will be appreciated that similar methods may be used to establish a developed potential for an embryo using different characteristics relating to the development of the study embryo and/or by combining the characteristics in a different way to generate a different quality parameter.

For example, while the first generalized irregularity variable GIV1 as described above is based on durations of cell cycles cc2a, cc2b, cc3a, cc3b, cc3c and cc3d (or at least the durations of the ones which are measured/not missing), other generalized irregularity variables may be based on durations of other cell cycles. For example, the following variations may be defined:

GIV2 (second generalized irregularity variable): similar to GIV1, but also including cc1, i.e. GIV2 may be calculated in a similar manner to GIV1, but based on cci=cc1, cc2a, cc2b, cc3a, cc3b, cc3c and cc3d.

GIV3 (third generalized irregularity variable): only including the second-generation cell cycles (cc2a and cc2b), i.e. GIV3 may be calculated in a similar manner to GIV1, but based on cci=cc2a and cc2b.

GIV4 (fourth generalized irregularity variable): only including the shortest cell cycle for the second- and third generations (cc2a and cc3a), i.e. GIV4 may be calculated in a similar manner to GIV1, but based on cci=cc2a and cc3a.

Whereas the above example generalized irregularity variables are based on cell cycle durations defined with respect to cell cleavage times, it will be appreciated that other generalized irregularity variables may be based on other timings (and/or durations between timings) which are associated with other embryonic developmental events. For example, a generalized irregularity variable used in accordance with some embodiments of the invention may be established using timings defined relative to the time of pronuclei fading (tPNf). One example, which may be referred to as GIV5, can be defined as follows:

GIV5 (fifth generalized irregularity variable): comprising (t3−tPNf) and cc3a.

In each case, if any of the characteristics comprising the generalized regularity variable are missing for an embryo (e.g. because they were not properly measured or had not occurred before the end of incubation time), the corresponding characteristic may be left out of the calculation of the variable (with the value of n correspondingly reduced).

Other variables may be determined from characteristics relating to the development of the study embryo other than cell cycle durations.

For example, a variation on the above-described implementation of the method of FIG. 6 may be as follows:

In step S1 the characteristics relating to the development of the study embryo may instead comprise a series of time differences Δtj between subsequent cell divisions (or morphological stages). For example, the plurality of characteristics may comprise a series of values: Δt1 (=t2); Δt2 (=t3−t2); Δt3 (=t4−t3); Δt4 (=t5−t4), Δt5 (=t6−t5), Δt6 (=t7−t6). Δt7 (=t8−t7)—i.e. the time differences between subsequent cell divisions up to the eight blastomeres stage. That is to say, for this example the sequence comprises all times between subsequent cell divisions from a single cell to an eight-blastomere embryo, or at least all of these times that are deemed to be properly measured (i.e. not missing).

In step S2 average and variance values seen in a population of positive KID embryos for the characteristics obtained for the study embryo in step S1 are obtained.

In step S3 a difference between the value of each characteristic seen for the study embryo and the corresponding average characteristic associated with the population of positive KID embryos is determined.

In step S4 a quality parameter for the study embryo (corresponding to a continuous variable) is determined by combining/aggregating the differences determined for each characteristic in a way which is weighted by the respective variance values. Thus in one specific example, a quality parameter (GTV) is defined as:

$$GTV = \frac{1}{k} {\sum }_{all j i n \\ sequence}^{ } \frac{Δ tj - Δ {tj}_{m}}{Δ {tj}_{v}} \qquad [ 2 ]$$

Where Δtj is the series of differences in times for subsequent cell divisions observed for the study embryo, Δtjₘ is the corresponding series of average values seen in a reference group of embryos (e.g. the positive KID population from patients under the age 35), and Δtjᵥ are the corresponding variance values associated with the reference population. The parameter k is the number of values comprising the series Δtj. The differences (Δtj−Δtₘ) are normalized by the variance values Δtjᵥ as part of the combining. This means that differences for particular cell divisions (values of j) which exhibit relatively high variance in the sample population contribute less to the value of GTV than for those which exhibit relatively low variance in the sample population. In this example the contribution to GTV for each time difference depends on whether the difference in times for a particular pair of subsequent cell divisions is faster or slower than the average seen in the positive KID population (i.e. whether the difference is positive or negative).

This particular quality parameter GTV may be referred to herein as a third generalized time variable, GTV3. Generally speaking GTV3 is low when the study embryo exhibits a relatively fast development and is high when the embryo exhibits a relatively slow development.

The particular quality parameter based on the particular sequence Δt1 (=t2); Δt2 (=t3−t2); Δt3 (=t4−t3); Δt4 (=t5−t4), Δt5 (=t6−t5), Δt6 (=t7−t6), Δt7 (=t8−t7), as in this example, may be referred to herein as a third generalized time variable GIV3.

In step S5 a development potential for the study embryo is established based on the quality parameter GTV3. This process is discussed generally further below.

In step S6 an indication of the establish development potential is output, for example on a display presented to a clinician.

It will again be appreciated that similar methods may be used to establish a developed potential for an embryo using different characteristics relating to the development of the study embryo.

For example, while the third generalized time variable GTV3 as described above is based on all times between subsequent cell divisions from a single cell to an eight-blastomere embryo, other generalized irregularity variables may be based on other sequences of time differences. For example, the following variations may be defined:

GTV1 (first generalized time variable): similar to GTV3 but using only the time difference of the last two cell divisions observed up to the 8 blastomere state. I.e. Δti=(t8−t7), if t7 and t8 are annotated; or Δti=(t7-t6) if t8 is missing and t6 and t7 are annotated; or Δti=(t6−t5) if t8 and t7 are missing and t5 and t6 are annotated; or Δti=(t5−t4) if t8, t7 and t6 are missing and t4 and t5 are annotated; or Δti=(t4−t3) if t5 to t8 are missing and t3 and t4 are annotated; or Δti=(t3−t2) if t4 to t8 are missing and t2 and t3 are annotated; Δti=t2 if t3 to t8 are missing and t2 is annotated. In each case the parameter k is 1.

GTV2 (second generalized time variable): similar to GTV1 but with the later division time (cleavage time) in a pair replaced with tEnd (the end of the incubation time) where timings are missing. I.e. Δti=(t8−t7), if t7 and t8 are annotated; or Δti=(tEnd−t7) if t8 is missing and t7 is annotated; or Δti=(tEnd−t6) if t7 and t8 are missing and t6 is annotated; or Δti=(tEnd−t5) if t6 to t8 are missing and t5 is annotated; or Δti=(tEnd−t4) if t5 to t8 are missing and t4 is annotated; or Δti=(tEnd−t3) if t4 to t8 are missing and t3 is annotated; or Δti=(tEnd−t2) if t3 to t8 are missing and t2 is annotated. Mean and variance values for the reference population may be calculated based on Δti without substitution. For GTV2 the parameter k is always 1.

GTV3 (third generalized time variable): as discussed above, this quality parameter uses timings between all consecutive divisions that are not missing from the data to the 8 blastomere stage. i.e. Δti=((t8−t7), (t7-t6), (t6-t5), (t5-t4), (t4-t3), (t3-t2), t2). If a Δti from this sequence is missing for a particular embryo, it is omitted from the calculation. The parameter k is the number of Δti used in the calculation for a particular embryo.

GTV4 (fourth generalized time variable): similar to GTV3 but using all consecutive divisions with substitution of the last division time with incubation end time if missing. Δti=((t8−t7),(t7−t6),(t6−t5),(t5−t4),(t4−t3),(t3−t2),t2). If a ti is missing it is substituted with the tEnd. Mean and variance values for the reference population may be calculated based on Δti without substitution. K is the number of Δti used in the calculation for that particular embryo.

GTV5 (fifth generalized time variable): similar to GTV3 but using timings for the full cell cycles. I.e. Δti=((t8−t4), (t4-t2), t2). If a Δti is missing it is omitted. k is the number of Δti used in the calculation for a particular embryo.

GTV6 (sixth generalized time variable): similar to GTV5 but using all full cell cycles with substitution of the last division time with tEnd if missing. Δti=((t8−t4),(t4−t2), t2). If a ti is missing it is substituted with tEnd. Mean and variance is calculated based in the Δti without substitution. k is the number of Δti used in the calculation for that particular embryo.

GTV7 (seventh generalized time variable): similar to GTV2 but using only the period from insemination to the last annotated timing. I.e. Δti=t8 if t8 is annotated, Δti=t7 if t8 is missing and t7 is annotated, Δti=t6 if t7 and t8 are missing and t6 is annotated, and no on. For GTV7 the parameter k is always 1.

GTV8 (eighth generalized time variable): similar to GTV3 but using t8 if it is annotated and otherwise using tEnd if t8 is missing. For GTV8 the parameter k is always 1.

GTV9 (ninth generalized time variable): similar to GTV2 but using stages up to the blastocysts stage for evaluation on day 5 post insemination. Δti=(tB−tSB), if both tSB and tB are annotated; or Δti=(tEnd−tSB), if tB is missing and tSB is annotated; or Δti=(tEnd−tM), if tSB and tB is missing and tM is annotated; or Δti=(tM−t8), if tM to tB is missing and t8 is annotate; or Δti=(tEnd−t7), if t8 to tB is missing and t7 is annotated; or Δti=(tEnd−t6) if t7 to tB are missing and t6 is annotated; or Δti=(tEnd−t5) if t6 to tB are missing and t5 is annotated; or Δti=(tEnd−t4) if t5 to tB are missing and t4 is annotated; or Δti=(tEnd−t3) if t4 to tB are missing and t3 is annotated; or Δti=(tEnd−t2) if t3 to tB are missing and t2 is annotated. Mean and variance may be calculated based on the Δti without substitution. For GTV9 the parameter k is always 1.

GTV10 (tenth generalized time variable): similar to GTV4 but using all stages up to the blastocyst stage. For evaluation on day 5 post insemination. Δti=((tB−tSB),(tSB−tM),(tM−t8), (t8-t7),(t7-t6),(t6-t5),(t5-t4),(t4-t3),(t3−t2),t2). If a timing is missing it is substituted with the tEnd. Mean and variance is calculated based on the Δti without substitution. For GTV10 the parameter k is the number of Δti used in the calculation for that particular embryo.

The developmental potential (quality) of an embryo can be based on one variable value, or multiple variable values. For example, with reference to the above specific examples, development potential for an embryo may be established based on a pair comprising one of the generalized irregularity variables (GIV1-4) and one of the generalized time variables (GTV1 to GTV8).

As well as establishing embryo quality using variable values obtained by the methods described herein, one may also take account of other quantitative measurements made on the embryo. This may include a comparison with online measurements such as blastomere motility, respiration rate, amino acid uptake etc. A combined dataset of blastomere motility analysis, respiration rates and other quantitative parameters may to improve embryo selection and reliably enable embryologist to choose the best embryos for transfer.

Thus, in one embodiment the method according to the invention may be combined with other measurements in order to evaluate the embryo in question, and may be used for selection of competent embryos for transfer to the recipient.

Such other measurements may, by way of example only, be selected from the group of respiration rate, amino acid uptake, motility analysis, blastomere motility, morphology, blastomere size, blastomere granulation, fragmentation, multinucleation, blastomere color, polar body orientation, nucleation, spindle formation and integrity, and numerous other qualitative measurements. The respiration measurement may be conducted as described in PCT publication no. WO 2004/056265 A1 (Unisense).

Embodiments of the present invention further provide methods for selecting an embryo for transplantation whereby embryos are monitored as discussed above to establish a predicted development potential for each embryo and wherein one or more embryos are selected for transplantation based on the respective development potentials. This selection or identifying method may be combined with other measurements in order to evaluate the quality of the embryo. Some potentially important criteria in a morphological evaluation of embryos are: (1) shape of the embryo including number of blastomeres and degree of fragmentation; (2) presence and quality of a zona pellucida; (3) size; (4) color and texture; (5) knowledge of the age of the embryo in relation to its developmental stage, and (6) blastomere membrane integrity. The transplantation may then be conducted by any suitable method known to the skilled person.

In a preferred embodiment the observations are conducted during cultivation of the cell population, such as wherein the cell population is positioned in a culture medium. Means for culturing cell population are known in the art. An example of culturing an embryo is described in PCT publication no. WO 2004/056265 A1 (Unisense). Thus the embryos may be cultured under any conventional conditions known in the art to promote survival, growth and/or development of the embryo, for instance may include the method and device and conditions taught in WO2004/056265 A1, which is incorporated herein by reference.

The invention further relates to a data carrier comprising a computer program directly loadable in the memory of a digital processing device and comprising computer code portions constituting means for executing the method of the invention as described above.

The data carrier may be a magnetic or optical disk or in the shape of an electronic card as for example the type EEPROM or Flash, and designed to be loaded into existing digital processing means.

### Examples

Data were obtained from five clinics for embryos in accordance with the respective clinics' conventional incubation and observation techniques. Time-lapse images were acquired of all embryos, but only transferred embryos with known implantation (i.e. either 0% implantation or 100% implantation) were investigated by detailed time-lapse analysis measuring the exact timing of the developmental events in hours-post-fertilization. ICSI was done according to the standard procedure used in the clinics. These standard procedures are known to the skilled person.

The present study is based on data for 1758 embryos transferred on day three and 288 embryos transferred at day five that were either KID positives or KID negatives from the five clinics. Table 1 shows how the data were distributed between the five clinics. All the embryos used in this analysis were from transfer up to day 3 or 5 and only from ICSI cycles with no biopsies. Cycles where some of the embryos were incubated without time-lapse were excluded from the analysis. The cleavage stages (timings) until the eights cells stage were used to estimate the various generalized irregularity and time variables defined above for each of the embryos. For each embryo the generalized irregularity and time variables were determined using the average and variance derived from the KID positive population for the clinic with which the embryo is associated.

TABLE 1
the number of known implantation data (KID) embryos from each
clinic transferred at day 3 or day 5 post insemination.

| | n (day 3) | n (day 5) |
|---|---|---|
| Clinic 1 | 279 | 119 |
| Clinic 2 | 271 | 50 |
| Clinic 3 | 158 | 20 |
| clinic 4 | 783 | 98 |
| clinic 5 | 267 | 1 |

### Incubation

The embryos were incubated in accordance with the respective clinics' conventional techniques.

### Imaging System

The embryos were imaged in accordance with conventional techniques. One example of a conventional imaging system is an EmbryoScope that uses low intensity red light (635 nm) from a single LED with short illumination times of 30 ms per image to minimize embryo exposure to light and to avoid damaging short wavelength light.

### Time-Lapse Evaluation of Morphokinetic Parameters

Retrospective analysis of the acquired images of each embryo was made with an external computer, EmbryoViewer® workstation (EV), (Unisense FertiliTech, Aarhus, Denmark) using image analysis software in which all the considered embryo developmental events were annotated together with the corresponding timing of the events in hrs after ICSI microinjection or IVF treatment. Subsequently the EV was used to identify the timings of the relevant embryo developmental events. The relevant events in the examples are those required to establish GIV and GTV as defined above for cleavage stages up to the eight cell stage. Times of the events were defined as the first observed timepoint/image frame where relevant event was apparent. All events are expressed as hours post ICSI microinjection or IVF treatment.

The detailed analysis was performed on transferred embryos with 100% implantation (i.e. where the number of gestational sacs confirmed by ultrasound matched the number of transferred embryos); and on embryos with 0% implantation, where no biochemical pregnancy was achieved.

### Example Results

Some statistics for various generalized irregularity and time variables such as defined above and determined in accordance with embodiments of the invention are presented in Tables 2A and 2B. Table 2A shows data for day 3 post insemination transfers and Table 2B shows data for day 5 post insemination transfers. As can be seen. Tables 2A and 2B are each is split into two parts, the upper part showing data for the example generalized irregularity variables GIV1 to GIV5 and the lower part showing data for the example generalized time variables (GTV1 to GTV8 in the case of Table 2A and GTV1 to GTV10 in the case of Table 2B).

TABLE 2A
statistics of the different variables with respect to KID positives and KID negatives
for day 3 transfer embryos.

| KID (day 3) | | GIV1 | GIV2 | GIV3 | GIV4 | GIV5 |
|---|---|---|---|---|---|---|
| negatives | N | 1345 | 1345 | 1345 | 1345 | 181 |
| | Min | 0.06 | 0.07 | 0.03 | 0.01 | 0.07 |
| | 25% quartile | 0.24 | 0.25 | 0.21 | 0.27 | 0.45 |
| | Median | 0.38 | 0.37 | 0.37 | 0.48 | 1.21 |
| | 75% quartile | 0.74 | 0.68 | 0.77 | 1.15 | 1.78 |
| | Max | 5.46 | 5.93 | 6.33 | 5.62 | 4.27 |
| positives | N | 413 | 413 | 413 | 413 | 24 |
| | Min | 0.07 | 0.08 | 0.04 | 0.03 | 0.05 |
| | 25% quartile | 0.19 | 0.19 | 0.18 | 0.22 | 0.28 |
| | Median | 0.28 | 0.27 | 0.29 | 0.36 | 0.54 |
| | 75% quartile | 0.41 | 0.39 | 0.49 | 0.58 | 0.80 |
| | Max | 2.66 | 2.01 | 3.31 | 2.84 | 1.98 |

| KID | | | | | | | | | |
|---|---|---|---|---|---|---|---|---|---|
| (day 3) | | GTV1 | GTV2 | GTV3 | GTV4 | GTV5 | GTV6 | GTV7 | GTV8 |
| neg. | N | 1345 | 1345 | 1345 | 1345 | 1345 | 1340 | 1345 | 1345 |
| | Min | −2.51 | −0.57 | −0.77 | −0.65 | −0.87 | −0.72 | −0.78 | −0.64 |
| | 25% quartile | −0.19 | −0.17 | −0.09 | −0.08 | −0.16 | −0.12 | −0.11 | −0.09 |
| | Median | −0.09 | 0.06 | 0.02 | 0.06 | 0.04 | 0.08 | 0.06 | 0.14 |
| | 75% quartile | 0.17 | 0.75 | 0.21 | 0.30 | 0.29 | 0.38 | 0.26 | 0.30 |
| | Max | 14.64 | 296.59 | 12.54 | 10.48 | 4.94 | 3.75 | 2.86 | 5.46 |
| pos. | N | 413 | 413 | 413 | 413 | 413 | 413 | 413 | 413 |
| | Min | −0.75 | −0.57 | −0.77 | −0.77 | −0.74 | −0.74 | −0.47 | −0.47 |
| | 25% quartile | −0.20 | −0.20 | −0.13 | −0.13 | −0.18 | −0.17 | −0.15 | −0.15 |
| | Median | −0.11 | −0.07 | −0.03 | −0.01 | −0.04 | −0.02 | −0.02 | 0.02 |
| | 75% quartile | 0.10 | 0.31 | 0.07 | 0.10 | 0.10 | 0.12 | 0.14 | 0.21 |
| | Max | 2.84 | 37.83 | 1.28 | 3.44 | 1.53 | 2.77 | 1.22 | 3.91 |

TABLE 2B
statistics of the different variables with respect to KID positives and KID negatives
for day 5 transfer embryos.

| KID (day 5) | | GIV1 | GIV2 | GIV3 | GIV4 | GIV5 |
|---|---|---|---|---|---|---|
| negatives | N | 155 | 155 | 155 | 155 | 56 |
| | Min | 0.08 | 0.08 | 0.03 | 0.02 | 0.07 |
| | 25% quartile | 0.23 | 0.24 | 0.21 | 0.27 | 0.36 |
| | Median | 0.34 | 0.34 | 0.34 | 0.38 | 0.49 |
| | 75% quartile | 0.55 | 0.52 | 0.68 | 0.61 | 1.14 |
| | Max | 2.48 | 1.90 | 5.30 | 5.30 | 2.27 |
| positives | N | 133 | 133 | 133 | 133 | 38 |
| | Min | 0.06 | 0.08 | 0.02 | 0.06 | 0.12 |
| | 25% quartile | 0.19 | 0.21 | 0.17 | 0.20 | 0.23 |
| | Median | 0.29 | 0.28 | 0.29 | 0.35 | 0.38 |
| | 75% quartile | 0.42 | 0.40 | 0.54 | 0.55 | 0.61 |
| | Max | 1.09 | 0.94 | 2.61 | 1.95 | 1.79 |

| KID | | | | | | | | | | | |
|---|---|---|---|---|---|---|---|---|---|---|---|
| (day 5) | | GTV1 | GTV2 | GTV3 | GTV4 | GTV5 | GTV6 | GTV7 | GTV8 | GTV9 | GTV10 |
| neg. | N | 155 | 155 | 155 | 155 | 155 | 155 | 155 | 155 | 154 | 154 |
| | Min | −0.37 | −0.30 | −0.54 | −0.54 | −0.60 | −0.60 | −0.41 | −0.41 | −0.49 | −0.42 |
| | 25% | −0.20 | −0.20 | −0.10 | −0.10 | −0.19 | −0.19 | −0.15 | −0.15 | −0.11 | −0.06 |
| | quartile | | | | | | | | | | |
| | Median | −0.09 | −0.07 | 0.01 | 0.02 | −0.002 | 0.001 | 0.02 | 0.04 | −0.04 | 0.018 |
| | 75% | 0.21 | 0.31 | 0.18 | 0.23 | 0.28 | 0.38 | 0.31 | 0.38 | 0.15 | 0.20 |
| | quartile | | | | | | | | | | |
| | Max | 2.77 | 8.53 | 4.94 | 4.94 | 1.45 | 1.54 | 1.71 | 3.01 | 2.54 | 3.85 |
| pos. | N | 133 | 133 | 133 | 133 | 133 | 133 | 133 | 133 | 133 | 133 |
| | Min | −0.57 | −0.57 | −0.84 | −0.84 | −0.82 | −0.82 | −0.42 | −0.42 | −0.43 | −0.43 |
| | 25% | −0.23 | −0.23 | −0.16 | −0.16 | −0.22 | −0.22 | −0.27 | −0.18 | −0.14 | −0.14 |
| | quartile | | | | | | | | | | |
| | Median | −0.15 | −0.15 | −0.06 | −0.06 | −0.04 | −0.03 | −0.06 | −0.06 | −0.04 | −0.03 |
| | 75% | 0.02 | 0.04 | 0.04 | 0.04 | 0.15 | 0.15 | 0.10 | 0.11 | 0.09 | 0.09 |
| | quartile | | | | | | | | | | |
| | Max | 2.39 | 3.95 | 0.66 | 0.66 | 0.76 | 0.77 | 0.83 | 1.61 | 1.10 | 1.10 |

The statistics represented in Tables 2A and 2B are based on data from embryos from several clinics. The results for the KID negative embryos are represented in the upper portions of the respective parts of the tables and the results for the positive KID embryos are represented in the lower portions of the respective parts of the tables. N is the total number of embryos used to generate the corresponding statistic. Min, 25% quartile, median, 75% quartile, and Max respectively represent the minimum value, first, second and third quartile values, and the maximum value seen for the respective variables in the respective populations.

From Tables 2A and 2B it can be seen the statistical values of the various variables are generally lower for the KID positive population as opposed to the KID negative population.

For the specific example variables discussed above there are five generalized irregularity variables (GIV1 to GIV5) and ten generalized time variables (GTV1 to GTV10). Some embodiments of the invention focus on different pairs of these variables, wherein each pair comprises one generalized irregularity variable selected from GIV1 to GIV5 and one generalized time variable selected from GTV1 to GTV10. Thus, there are 50 different pairs of variables that may be selected from among these examples. For each of the 40 different pairs associated with GIV1 to GIV5 and GTV1 to GTV8 (i.e. 40 different combinations of one of GIV1 to GIV5 and one of GTV1 to GTV8) a logistical regression model was estimated using standard statistical techniques and according to following form:

$$ln ( OD ) = ln ( \frac{{p}_{i}}{( 1 - {p}_{i} )} ) = {α}_{0} + {α}_{clinic} + {β}_{GIV} {GIV}_{i} + {β}_{GTV} {GTV}_{i} + ɛ \qquad [ 3 ]$$

where OD is the odds, (pi/(pi−1)), of successful embryo implantation, pi is the probability of implantation, α₀ is an estimated intercept for the model, α_{clinic} represents the estimated effect of the clinic on the intercept for the model. β_{GIV} is the estimated coefficient of the specific GIV variable GIVᵢ (where i=1 to 5) for the model. β_{GTV} is the estimated coefficient of the specific GTV variable GTVᵢ (where i=1 to 8 for day 3 transfers and 1 to 10 for day 5 transfers) for the model and ε is the estimated error for the model.

Table 4A shows the area under curve (AUC) determined for the receiver operating characteristic (ROC) curves associated with the models estimated in accordance with Equation 3 for the respective pairs (combinations) of GIV and GTV for day 3 post insemination transfers. Table 4B shows corresponding values for day 5 post insemination transfers. For some of the combinations it was determined (using standard statistical techniques, such as the Akaike information criterion, AIC) that the effect of the GTV variable was not significant. These combinations are identified by the dagger symbol “†” in the relevant cell of the table (e.g. for (GTVᵢ, GIVᵢ)=(GTV1, GIV1) and (GTV1, GIV2) in Table 4A, and others). For the GIV5 column, data from only one clinic were used. An AUC of 0.65 may, for example, be considered as an acceptable threshold.

TABLE 4A
AUC of the ROC curve of the models estimated with combinations of
different types of GIV and GTV for day 3 post insemination data.

| AUC | GIV1 | GIV2 | GIV3 | GIV4 | GIV5 |
|---|---|---|---|---|---|
| GTV1 | 0.67† | 0.68† | 0.65 | 0.66 | 0.70† |
| GTV2 | 0.67 | 0.69 | 0.65 | 0.66 | 0.73† |
| GTV3 | 0.67 | 0.68 | 0.66 | 0.67 | 0.74 |
| GTV4 | 0.68 | 0.68 | 0.66 | 0.67 | 0.75 |
| GTV5 | 0.67 | 0.68† | 0.65 | 0.66 | 0.75 |
| GTV6 | 0.68 | 0.68 | 0.66 | 0.67 | 0.77 |
| GTV7 | 0.67† | 0.68† | 0.65 | 0.66 | 0.72† |
| GTV8 | 0.67† | 0.68† | 0.65 | 0.66 | 0.73† |

TABLE 4B
AUC of the ROC curve of the models estimated with combinations of
different types of GIV and GTV for day 5 post insemination data.

| AUC | GIV1 | GIV2 | GIV3 | GIV4 | GIV5 |
|---|---|---|---|---|---|
| GTV1 | 0.68† | 0.68† | 0.68 | 0.69 | 0.69 |
| GTV2 | 0.69 | 0.69 | 0.69 | 0.69 | 0.70 |
| GTV3 | 0.68 | 0.68 | 0.68 | 0.69 | 0.67 |
| GTV4 | 0.69 | 0.69 | 0.69 | 0.69 | 0.67 |
| GTV5 | 0.68 | 0.68† | 0.67 | 0.67 | 0.66 |
| GTV6 | 0.68 | 0.68 | 0.67 | 0.67 | 0.66 |
| GTV7 | 0.68† | 0.68† | 0.67 | 0.68 | 0.67 |
| GTV8 | 0.69 | 0.69 | 0.68 | 0.68 | 0.68 |
| GTV9 | 0.68 | 0.68 | 0.66 | 0.68 | 0.66† |
| GTV10 | 0.69 | 0.70 | 0.69 | 0.70 | 0.69 |

Table 5A shows the Akaike information criterion. AIC, determined for the models estimated in accordance with Equation 3 for the respective pairs (combinations) of GIV and GTV for day 3 transfers. Table 5B shows corresponding values for day 5 post insemination transfers. As noted above, it was determined using standard statistical techniques that the effect of the GTV variable was not significant for the combinations identified by the dagger symbol “†” in the relevant cell of the table. For the GIV5 column, data from only one clinic were used.

TABLE 5A
Akaike information criterion, AIC, of the models
estimated with combinations of different types
of GIV and GTV for day 3 transfers.

| AIC | GIV1 | GIV2 | GIV3 | GIV4 | GIV5 |
|---|---|---|---|---|---|
| GTV1 | 1802† | 1793† | 1829 | 1807 | 141† |
| GTV2 | 1798 | 1786 | 1828 | 1806 | 138† |
| GTV3 | 1797 | 1788 | 1815 | 1800 | 138 |
| GTV4 | 1793 | 1784 | 1812 | 1796 | 135 |
| GTV5 | 1799 | 1792† | 1826 | 1806 | 137 |
| GTV6 | 1787 | 1785 | 1814 | 1796 | 134 |
| GTV7 | 1803† | 1793† | 1825 | 1808 | 140† |
| GTV8 | 1803† | 1793† | 1832 | 1812 | 148† |

TABLE 5B
Akaike information criterion, AIC, of the models
estimated with combinations of different types
of GIV and GTV for day 5 transfers.

| AIC | GIV1 | GIV2 | GIV3 | GIV4 | GIV5 |
|---|---|---|---|---|---|
| GTV1 | 378 | 376† | 383 | 379 | 120 |
| GTV2 | 375 | 372 | 380 | 376 | 120 |
| GTV3 | 372 | 371 | 374 | 371 | 123 |
| GTV4 | 369 | 368 | 371 | 368 | 122 |
| GTV5 | 377 | 376† | 381 | 378 | 124 |
| GTV6 | 375 | 374 | 379 | 375 | 123 |
| GTV7 | 377† | 376† | 380 | 377 | 122 |
| GTV8 | 375 | 374 | 378 | 377 | 121 |
| GTV9 | 374 | 372 | 381 | 378 | 126 |
| GTV10 | 365 | 364 | 366 | 364 | 120 |

It can be seen from Table 4 that models for all combinations of the generalized variables are associated with AUC values greater than or equal to 0.65, which indicates all models can be usefully used for ranking embryos under study. Four example combinations of GIV and GTV for day 3 transfers which provide models with relatively high AUC and relatively low AIC are: Selected pairing 1=GTV6 and GIV1 (AUC=0.69, AIC=1787); Selected pairing 2=GTV2 and GIV2 (AUC=0.68 AIC=1786); Selected pairing 3=GTV4 and GIV2 (AUC=0.68 AIC=1784); and selected pairing 4=GTV6 and GIV2 (AUC=0.68 AIC=1785). Two example combinations of GIV and GTV for day 5 transfers which provide models with relatively high AUC and relatively low AIC are: Selected pairing 5=GTV10 and GIV2 (AUC=0.70, AIC=364); Selected pairing 6=GTV10 and GIV4 (AUC=0.70, AIC=364).

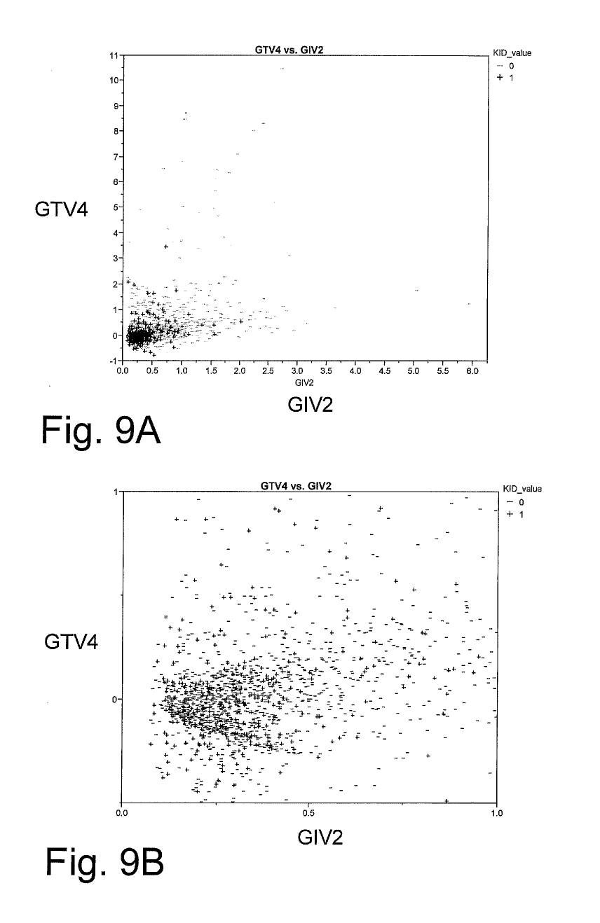

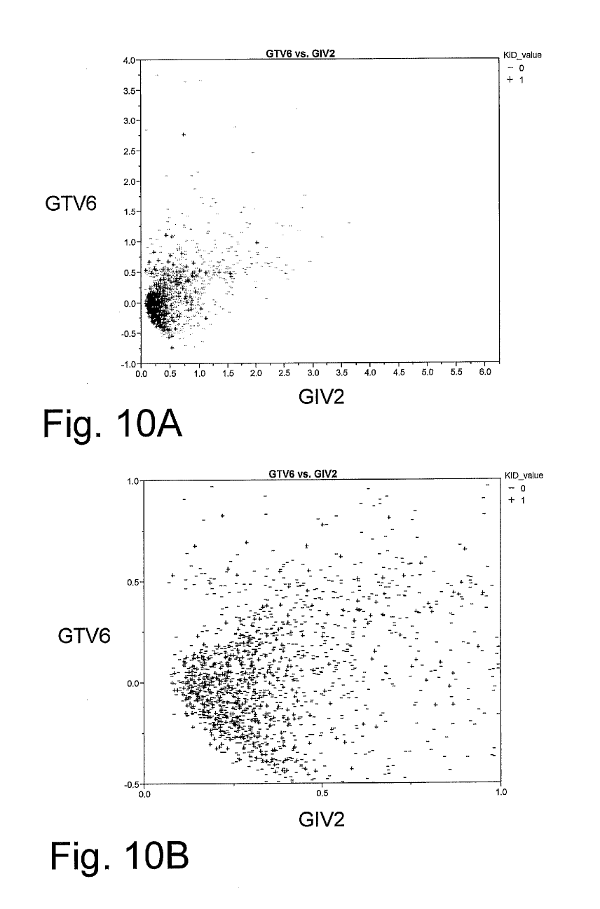

FIG. 7A schematically plots GTV6 against GIV1 for day 3 transfers (i.e. the variables associated with selected pairing 1 for the population of KID embryos comprising the study). Data for positive KID embryos are shown as plus-symbols (+) and data for negative KID embryos are shown as minus-symbols (−). FIG. 7B shows some of the same data as FIG. 7A but on a magnified scale (as indicated by the labeling on the respective axes).

FIGS. 8A and 8B are similar to and will be understood from FIGS. 7A and 7B, but plot data for the variables associated with selected pairing 2 identified above (i.e. GTV2 against GIV2 for day 3 transfers).

FIGS. 9A and 9B are similar to and will be understood from FIGS. 7A and 7B, but plot data for the variables associated with selected pairing 3 identified above (i.e. GTV4 against GIV2 for day 3 transfers).

FIGS. 10A and 10B are similar to and will be understood from FIGS. 7A and 7B, but plot data for the variables associated with selected pairing 4 identified above (i.e. GTV6 against GIV2 for day 3 transfers).

FIGS. 7 to 10 show for each example selected pairing there is an increased incidence of KID positives in the region of the respective plots corresponding with low values of GIV and GTV relative to the KID negatives. This is an indication of the ability of the respective variables to discriminate KID positive and KID negative events.

It will be appreciated that there may be other factors which affect the likelihood of successful implantation for a given embryo in addition to the effects associated with GTV, GIV and clinic which are incorporated in the linear regression models based on Equation 3. For example, variables such as the presence or absence of multinucleation at the two and four cell stage (MN2 and MN4), the presence or absence of unevenness in blastomere sizes at the two and four cell stage (UE2 and UE4), the patient's age at the time of treatment (Age) and the dependence of various parameters on the clinic. As regards unevenness, a blastomere may be considered to be unevenly sized at the two and/or four cell stage if a characteristic (e.g. average) diameter of the largest blastomere is, for example, more than 25% larger than a characteristic (e.g. larger than a characteristic (e.g. average) diameter of the smallest blastomere. Unevenness is most simply characterised among cells which have undergone the same number of divisions (for example when the embryo is at the two and/or four cell stage). This is because there is typically a difference in size between cells that have undergone different numbers of divisions. For example, in a three cell embryo the slowest blastomere (i.e. the one expected to divide next) will be larger before it divides that afterwards.

With this in mind further logistic regression models were estimated for the four selected pairings of variables represented in FIGS. 7 to 10 (based on day 3 transfers) and also for the selected pairings 5 and 6 identified above (based on day 5 transfers. For each of the six selected pairings a logistical regression model was estimated using standard statistical techniques and according to following form:

$$ln ( OD ) = ln ( \frac{{p}_{i}}{( 1 - {p}_{i} )} ) = {α}_{0} + {α}_{clinic} + {α}_{MN 2} MN2 + {α}_{MN 4} MN 4 + {α}_{UE 2} UE 2 + {α}_{UE 4} UE 4 + {β}_{Age} {Age}_{i} + {β}_{GIV} {GIV}_{i} + {β}_{GTV} {GTV}_{i} + {β}_{Age , clinic} {Age}_{i} + {β}_{GIV , clinic} {GIV}_{i} + {β}_{GTV , clinic} {GTV}_{i} + ɛ \qquad [ 4 ]$$

where OD is the odds, (pi/(pi−1)), of successful embryo implantation, pi is the probability of implantation, α₀ is an estimated intercept for the model, α_{clinic} represents the estimated effect of the clinic on the intercept for the model, MN2, MN4, UE2 and UE4 take the value 1 if true and 0 if false for the embryo, α_{MN2}, α_{MN4}, α_{UE2}, α_{UE4} respectively represent the estimated effects of MN2, MN4, UE2 and UE4 (when true) on the intercept for the model. β_{Age} is the estimated coefficient of the patient's age for the model, β_{Age,clinic} represents differences in the impact of the patient's age for different clinics. β_{GIV} is the estimated coefficient of the specific GIV variable for the model, β_{GIV,clinic} represents differences in the impact of GIV for the different clinics, β_{GTV} is the estimated coefficient of the specific GTV variable for the model, β_{GTV,clinic} represents differences in the impact of GTV for the different clinics, and is the estimated error for the model.

As discussed further below, various elements of Equation [4] may be identified as not having a significant impact on the model (i.e. In(OD) not having a strong dependence on the element). In this regard, some of the elements may be removed from the model represented by Equation 4 (the “full” model) to provide what might be termed a “reduced” model. Furthermore, the inventors have recognized that different terms can have different significance for different models, for example a term that is determined to be statistically significant for distinguishing KID positive and KID negative embryos for day 3 transfers might be determined to be not statistically significant for distinguishing KID positive and KID negative embryos for day 5 transfers. Thus for the four different combinations of GIV and GTV corresponding to the selected pairings 1 to 4 a reduced model for day 3 transfers may be represented as follows:

ln(OD)=α₀+α_{clinic}+α_{MN2}MN2+α_{MN4}MN4+β_{Age}Ageᵢ+β_{GIV}GIVᵢ+β_{GTV}GTVᵢ+β_{Age,clinic}Ageᵢ+ε [5a]

And for the two different combinations of GIV and GTV corresponding to the selected pairings 5 and 6 a reduced model for day 5 transfers may be represented as follows:

ln(OD)=α₀+α_{clinic}+α_{MN4}MN4+β_{Age}Ageᵢ+β_{GIV}GIVᵢ+β_{GTV}GTVᵢ+ε [5b]

Thus the elements removed from the “full” model to provide the “reduced” models represented in Equations 5a (for day 3 transfers) and 5b (for day 5 transfers) are those relating to unevenness (UE2, UE4) and the impact of the different clinics on GIV and GTV (βGIV,clinic, β_{GTV,clinic}). In addition the elements relating to multi-nuclearity at the two cell stage (MN2) and the clinic dependence on age (β_{Age,clinic}Age) are removed from the “full” model for the day 5 transfer “reduced” model (Equation 5b).

Table 6 presents values for variables associated with the model defined by Equations 4 and 5a determined for the first selected pairing of GTV6 and GIV1 for day 3 transfers. The AUC for the ROC for the reduced model for this selected pairing is 0.70. The top row of the table shows the AIC determined for the full model.

TABLE 6
values for variables associated with the models defined by Equations
4 and 5a for the pairing GTV6 and GIV1 for day 3 transfers

| | | | AIC of model |
|---|---|---|---|
| | estimate | significance | without |
| variable | (reduced model) | (reduced model) | variable |
| Full model | | | 1773 |
| intercept (clinic1) | 2.32 | . | |
| clinic2 | 1.58 | ns | |
| clinic3 | −2.46 | ns | |
| clinic4 | −2.63 | . | |
| clinic5 | 0.25 | ns | |
| GIV1 | −1.17 | *** | |
| GTV6 | −0.70 | *** | |
| Age (clinic1) | −0.09 | ** | |
| clinic*GIV1 | — | ns | 1769 |
| clinic*GTV6 | — | ns | 1769 |
| clinic2*Age | −0.02 | | 1780 |
| clinic3*Age | 0.11 | * | |
| clinic4*Age | 0.09 | * | |
| clinic5*Age | −0.002 | | |
| MN2 (true) | −0.36 | ** | 1778 |
| MN4 (true) | −0.37 | . | 1774 |
| UE2 (true) | — | ns | 1771 |
| UE4 (true) | — | ns | 1772 |

The first (left-most) column in Table 6 lists the respective variables, the second column lists the corresponding parameter estimate for the variable determined from the logistical regression modeling based on Equation 5a (the reduced model for day 3 transfers), the third column characterizes the statistically-determined significance of the variable in the full model (Equation 4). The fourth (right-most) column lists the AIC determined for a model corresponding to the full model (Equation 4), but with the relevant variable removed. In accordance with conventional statistical techniques, a reduction in AIC associated with removal of a particular variable from the full model is taken as an indicator that the variable is not a significant parameter of the full model. The significance indicated in the third column is characterized as “ns” if determined to be not significant, and by an increasing number of asterisks (“*”) for increasing significance. In this regard, the significance is characterized based on p-value determined in accordance with conventional statistical techniques. A p-value of less than 0.001 is classified herein by three asterisks (“***”), a p-value equal to or greater than 0.001 and less than 0.01 is classified herein by two asterisks (“***”), a p-value equal to or greater than 0.01 and less than 0.05 is classified herein by one asterisk (“**”), and a p-value equal to or greater than 0.05 and less than 0.1 is classified herein by a dot (“.”).

Table 7 is similar to, and will be understood from Table 6, but relates to the second selected pairing GTV2 and GIV2 for day 3 transfers. The AUC for the ROC for the reduced model in this case is 0.71.

TABLE 7
values for variables associated with the models defined by Equations
4 and 5a for the GTV2 and GIV2 for day 3 transfers.

| | | | AIC of full |
|---|---|---|---|
| | estimate | significance | model without |
| variable | (reduced model) | (reduced model) | variable |
| Full model | | | 1769 |
| intercept (clinic1) | 2.43 | . | — |
| clinic2 | 1.29 | ns | — |
| clinic3 | −2.51 | ns | |
| clinic4 | −2.52 | . | |
| clinic5 | 0.37 | ns | |
| GIV2 | −1.69 | *** | — |
| GTV2 | −0.06 | * | — |
| Age (clinic1) | −0.09 | ** | — |
| clinic*GIV2 | — | ns | 1766 |
| clinic*GTV2 | — | ns | 1768 |
| clinic2*Age | −0.01 | | 1775 |
| clinic3*Age | 0.11 | * | |
| clinic4*Age | 0.09 | * | |
| clinic5*Age | −0.007 | | |
| MN2 (true) | −0.39 | ** | 1774 |
| MN4 (true) | −0.36 | . | 1770 |
| UE2 (true) | — | ns | 1767 |
| UE4 (true) | — | ns | 1768 |

Table 8 is similar to, and will be understood from Table 6, but relates to the third selected pairing GTV4 and GIV2 for day 3 transfers. The AUC for the ROC for the reduced model in this case is 0.71.

TABLE 8
values for variables associated with the models defined by Equations
4 and 5a for the pairing GTV4 and GIV2 for day 3 transfers.

| | | | AIC of full |
|---|---|---|---|
| | estimate | significance | model without |
| variable | (reduced model) | (reduced model) | variable |
| Full model | | | 1769 |
| intercept (clinic1) | 2.38 | . | — |
| clinic2 | 1.55 | ns | — |
| clinic3 | −2.43 | ns | |
| clinic4 | −2.57 | . | |
| clinic5 | 0.54 | ns | |
| GIV2 | −1.49 | *** | — |
| GTV4 | −0.47 | ** | — |
| Age (clinic1) | −0.09 | ** | — |
| clinic*GIV2 | — | ns | 1766 |
| clinic*GTV4 | — | ns | 1761 |
| clinic2*Age | −0.02 | | 1776 |
| clinic3*Age | 0.11 | * | |
| clinic4*Age | 0.09 | * | |
| clinic5*Age | −0.011 | | |
| MN2 (true) | −0.37 | ** | 1773 |
| MN4 (true) | −0.37 | . | 1770 |
| UE2 (true) | — | ns | 1766 |
| UE4 (true) | — | ns | 1761 |

Table 9 is similar to, and will be understood from Table 6, but relates to the fourth selected pairing GTV6 and GIV2 for day 3 transfers. The AUC for the ROC for the reduced model in this case is 0.71.

TABLE 9
values for variables associated with the models defined by Equations
4 and 5a for the GTV6 and GIV2 for day 3 transfers.

| | | | AIC of full |
|---|---|---|---|
| | estimate | significance | model without |
| variable | (reduced model) | (reduced model) | variable |
| Full model | | | 1766 |
| intercept (clinic1) | 2.51 | . | — |
| clinic2 | 1.47 | ns | — |
| clinic3 | −2.55 | ns | |
| clinic4 | −2.67 | . | |
| clinic5 | 0.15 | ns | |
| GIV2 | −1.53 | *** | — |
| GTV6 | −0.64 | ** | — |
| Age (clinic1) | −0.09 | ** | — |
| clinic*GIV2 | — | ns | 1760 |
| clinic*GTV6 | — | ns | 1764 |
| clinic2*Age | −0.02 | | 1773 |
| clinic3*Age | 0.11 | * | |
| clinic4*Age | 0.09 | * | |
| clinic5*Age | −0.002 | | |
| MN2 (true) | −0.36 | ** | 1770 |
| MN4 (true) | −0.37 | . | 1767 |
| UE2 (true) | — | ns | 1763 |
| UE4 (true) | — | ns | 1765 |

Table 10 is similar to, and will be understood from Table 6, but relates to the fifth selected pairing GTV10 and GIV2 for day 5 transfers (and hence is based on the reduced model of Equation 5b. The AUC for the ROC for the reduced model in this case is 0.73.

TABLE 10
values for variables associated with the models defined by Equations
4 and 5b for the GTV10 and GIV2 for day 5 transfers.

| | estimate | | AIC of model |
|---|---|---|---|
| variable | (reduced model) | significance | without variable |
| Full model | | | 370 |
| intercept (clinic1) | 2.86 | ** | |
| clinic2 | 1.45 | ** | |
| clinic3 | 0.87 | . | |
| clinic4 | 0.09 | | |
| GIV2 | −1.02 | . | |
| GTV10 | −2.13 | ** | |
| Age (clinic1) | −0.08 | * | |
| clinic*GIV2 | — | ns | 367 |
| clinic*GTV10 | — | ns | 366 |
| clinic*Age | — | ns | 365 |
| MN2 (true) | — | ns | 368 |
| MN4 (true) | −1.29 | . | 372 |
| UE2 (true) | — | ns | 370 |
| UE4 (true) | — | ns | 370 |

Table 11 is similar to, and will be understood from Table 6, but relates to the sixth selected pairing GTV10 and GIV4 for day 5 transfers. The AUC for the ROC for the reduced model in this case is 0.73.

TABLE 11
values for variables associated with the models defined by Equations
4 and 5b for the GTV10 and GIV4 for day 5 transfers.

| | estimate | | AIC of model |
|---|---|---|---|
| variable | (reduced model) | significance | without variable |
| Full model | | | 372 |
| intercept (clinic1) | 2.83 | ** | |
| clinic2 | 1.43 | ** | |
| clinic3 | 0.95 | . | |
| clinic4 | 0.01 | | |
| GIV4 | −0.57 | . | |
| GTV10 | −2.44 | *** | |
| Age (clinic1) | −0.08 | ns | 367 |
| clinic*GIV4 | — | ns | 366 |
| clinic*GTV10 | — | ns | 369 |
| clinic*Age | — | ns | 367 |
| MN2 (true) | — | ns | 370 |
| MN4 (true) | −1.31 | . | 374 |
| UE2 (true) | — | ns | 371 |
| UE4 (true) | — | ns | 372 |

As can be seen from each of Tables 6 to 11, for each selected pairings the AIC determined for the full model without the variables relating to the interaction of clinic and the respective generalized variables (GIVᵢ and GTVᵢ) is in all cases lower than the AIC determined for the full model. In accordance with standard statistical techniques, this is taken to be an indication that the respective models are not significantly dependent on the identity of the clinic as regards GIV and GTV. Similar, it can be seen from the AIC values in Tables 6 to 11 associated with UE2 and UE4 that these are also not statistically significant for these models. Values associated with multi-nuclearity at the two cell stage (MN2) and the clinic dependence on age (β_{Age,clinic}Age) are also not statistically significant for the day 5 transfer examples presented here (Tables 10 and 11). This supports the absence of a contribution from these various elements in the reduced models represented by Equations 5a and 5b. In the context of seeking to establish a model for assessing embryo quality, it is generally beneficial if the same aspects of a given model can be applied for embryos incubated at different clinics.

Thus, an approach in accordance with embodiments of the invention can provide models for predicting the odds of successful embryo implantation using variables such as those defined above derived from time-lapse imaging of embryos to identify timings of particular developmental events. Furthermore, the AUC of the ROC curves for the six example reduced models presented herein are all around 0.70 to 0.73, which indicates all six models can be considered “good” models.

Based on the reduced model represented by Equation 5a, a determination of the absolute odds of implantation success for a specific embryo for day 3 transfers should take account of the patient's age and clinic. Based on the reduced model represented by Equations 5b (day 5 transfers), a determination of the absolute odds of implantation success for a specific embryo should take account of the patient's age. However, it will be appreciated that in general the task of assessing the development potential of an embryo is primarily about ranking a cohort of embryos from a given patient treated at a given clinic. That is to say, it is often the case that one wishes to establish which of a cohort of embryos has the highest odds, without needing to determine what those odds are (i.e. the developmental potential of interest may be an assessment of what is the best embryo from a sample, regardless of how good the embryo actually is). In this respect, elements of the reduced model of FIG. 5 that are constant for a given patient can be ignored for the purposes of establishing a quality parameter that allows different embryos from the same patient to be compared with one another in one fertility treatment cycle.

In this respect, the reduced models of Equations 5a and 5b which are intended to predict the actual odds of implantation success can be reduced further still to provide an equation which gives what might be termed a model score that allows different embryos from the same fertility treatment cycle to be compared relative to one another. Thus the model score may be defined for day 3 transfers as:

Model Scoreᵢ=α₀+α_{MN2}MN2+α_{MN4}MN4+β_{GIV}GIVᵢ+β_{GTV}GTVᵢ [6a]

and for day 5 transfers as:

Model Scoreᵢ=α₀+α_{MN4}MN4+β_{GIV}GIVᵢ+β_{GTV}GTVᵢ [6b]

Equation 6a corresponds with Equation 5a, but with the parameters that are constant for a given patient (i.e. parameters relating to age and clinic, namely α_{clinic}, β_{Age}Age, and β_{Age,clinic}Age) removed. Likewise, Equation 6b corresponds with Equation 5b, but with the parameters that are constant for a given patient removed.

The higher the model score, the better the embryo. In principle, the intercept parameter α₀ could also be removed as a constant, but the Inventors have recognized that without the intercept parameter the model score as defined by Equations 6a and 6b above will frequently give rise to negative numbers, which is perhaps perceived as being less intuitive to consider when ranking scores from different embryos according to which is the highest.

Thus model score defined by Equations 6a (for day 3 transfers) and Equation 6b (for day 5 transfers) will rank a cohort of embryos from a given fertility treatment cycle in the same way as the corresponding reduced models of Equations 5a and 5b. However, an advantage of relying on the model score of Equation 6a or 6b as opposed to an actual prediction of odds provided by Equations 5a and 5b is that it uses information that is available to a person evaluating the embryos only from time-lapse movies and does not require any patient or clinic specific information.

Based on the model score of Equations 6a and 6b, the six example pairings of generalized variables identified above provide the following equations that may be used for ranking embryos (these are determined by substituting the parameters represented in Tables 6 to 11 in Equation 6a or 6b as appropriate):

Model1 Scoreᵢ=2.32−0.36MN2−0.37MN4−1.17GIV1ᵢ−0.70GTV6ᵢ [7]

Model2 Scoreᵢ=2.43−0.39MN2−0.36MN4−1.69GIV2ᵢ−0.06GTV2ᵢ [8]

Model3 Scoreᵢ=2.38−0.37MN2−0.37MN4−1.49GIV2ᵢ−0.47GTV4ᵢ [9]

Model4 Scoreᵢ=2.51−0.36MN2−0.37MN4−1.53GIV2ᵢ−0.64GTV6ᵢ [10]

Model5 Scoreᵢ=2.86−1.29MN4−1.02GIV2ᵢ−2.13GTV10ᵢ [11]

Model6 Scoreᵢ=2.83−1.31MN4−0.57GIV4ᵢ−2.44GTV10ᵢ [12]

It will be appreciated these are merely some example ways in which a model score for an embryo may be determined in accordance with some embodiments of the invention. Other examples may be based on different combinations of the example GTV and GIV parameters discussed above, or indeed other parameters obtained by combining a plurality of other characteristics associated with the morphokinetic development of an embryo in a way which takes account of reference values for the characteristics. Thus, it will be appreciated that the specific characteristics employed in the above examples (i.e. based on selected pairings of the example GIV and GTV characteristics presented above) are merely some of many possible examples and in accordance with other implementations of embodiments of the invention other characteristics may be used. In particular, whereas some of the above examples have focused on developmental events associated with embryonic development to an eight-blastomere stage, it will be appreciated from the other examples that other implementations may in addition or in the alternative be based on later-stage developmental events. For example, in accordance with some other implementations of embodiments of the invention, characteristics associated with the timings of blastocyst events (i.e. blastocyst related variables) may be used in a corresponding manner to that described above, for example based on the GTV9 and GTV10 variables discussed above.

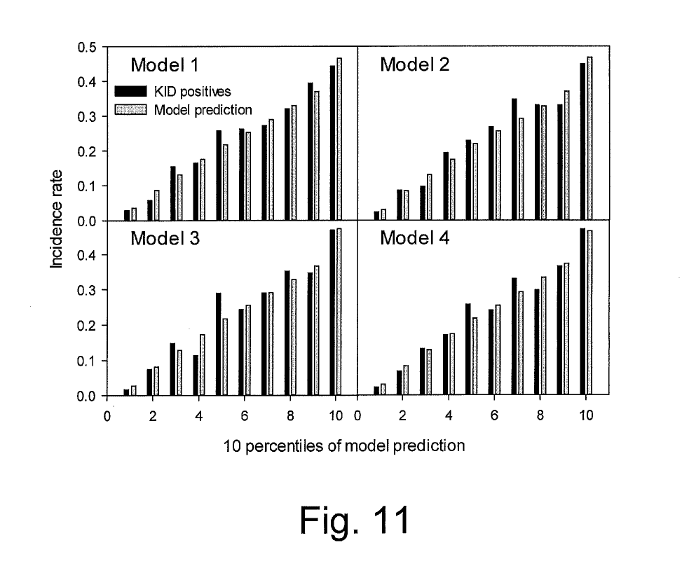

FIG. 11 schematically plots for each of four day 3 transfer reduced models (as defined by Equation 5a) based on respective ones of the above-identified four selected pairings, incidence rates for the KID embryos comprising the study when ranked according to the respective model (model prediction) in order of increasing embryo development potential (increasing predicted odds of implantation success) in 10 percentile bands. Actual incidence data for the corresponding embryos are also shown (KID positives). As can be seen, for all models there is a good correlation between the predictions and the actual incidence rates, which is a measure of the respective models ability to predict the developed potential of embryos.

Whilst the above examples have focused on KID positive and KID negative data relating to implantation success, an assessment of the quality/development potential of an embryo in accordance with some embodiments of the invention may comprise determining a potential for reaching a different developmental event. For example determining a development potential/quality of an embryo may comprise determining a measure of the likelihood of the embryo to develop to blastocyst stage, to implant, to result in pregnancy, and/or to result in a live-born baby.

Thus, in accordance with some of the principles described herein, a population of KID data may be used to generate models for determining an embryonic quality variable/development potential (e.g. odds of implementation and/odds of developing to a blastocyst) from one or more continuous variables obtained by combining differences between values of a plurality of characteristics relating to the development of an embryo during an observation period and corresponding reference values. A value for the one or more continuous variable(s) may then be established by observing some or all of the relevant developmental events in a study embryo, and then the model used to predict the development potential of the study embryo from its associated continuous variable(s).

Thus there has been described methods for determining a development potential for an embryo, for example an in vitro incubating human embryo, and apparatus for implementing such methods. In some examples a method comprises obtaining values for a plurality of morphokinetic characteristics relating to the development of an embryo during an observation period, for example characteristics relating to the temporal or morphological development of the embryo. A value for a continuous variable is determined by combining differences between the obtained values for these characteristics and corresponding reference values in a pre-defined manner. The reference values may, for example, be determined from values for the plurality of characteristics obtained for at least one reference embryo of known development potential. A development potential for the embryo is then established based on the determined value for the continuous variable.

Any publications mentioned in the above specification are herein incorporated by reference.

Various modifications and variations of the described methods and system of the present invention will be apparent to those skilled in the art without departing from the scope and spirit of the present invention. Although the present invention has been described in connection with specific preferred embodiments, it should be understood that the invention as claimed should not be unduly limited to such specific embodiments. Indeed, various modifications of the described modes for carrying out the invention which are obvious to those skilled in embryology, biochemistry and biotechnology or related fields are intended to be within the scope of the following claims.

### REFERENCES

Lemmen J G, Agerholm I & Ziebe S (2008) Kinetic markers of human embryo quality using time-lapse recordings of IVF/ICSI-fertilized oocytes. Reprod Biomed Online 17: 385-391.
Lundin K. Bergh C & Hardarson T (2001) Early embryo cleavage is a strong indicator of embryo quality in human IVF. Hum Reprod 16: 2652-2657.
Meseguer M, Herrero J, Tejera A, Hilligsoe K M, Ramsing N B & Remohi J (2011) The use of morphokinetics as a predictor of embryo implantation. Hum Reprod 26: 2658-2671.
WO 2012/163363 A1 (Unisense Fertilitech)
WO 2013/004239 A1 (Unisense Fertilitech)
WO 2011/025736 A1 (The Board of the Trustees of the Leland Stanford Junior University)
U.S. Pat. No. 7,963,906 B2 (The Board of the Trustees of the Leland Stanford Junior University)
Wong C C et al. (2010) Non-invasive imaging of human embryos before embryonic genome activation predicts development to the blastocyst stage, Nature Biotechnology 28, 1115-1121
Singleton, et al., Dictionary of Microbiology and Molecular Biology, 20 Ed., John Wiley and Sons, New York (1994),
Hale & Marham, The Harper Collins Dictionary of Biology, Harper Perennial, NY (1991)
WO 2007/042044 A1 (Unisense Fertilitech)
WO 2004/056265 A1 (Unisense)
Ottosen L D, Hindkjaer J & Ingerslev J (2007) Light exposure of the ovum and preimplantation embryo during ART procedures. J Assist Reprod Genet 24, 99-103.

1. A method for determining a development potential for an embryo, the method comprising:
obtaining values for a plurality of characteristics relating to the development of the embryo during an observation period;
determining a value for a continuous variable by combining differences between the obtained values and corresponding reference values for the plurality of characteristics in a pre-defined manner; and
establishing a development potential for the embryo based on the determined value for the continuous variable.

2. The method of claim 1, wherein the reference values are determined from values for the plurality of characteristics obtained for at least one reference embryo of known development potential.

3. The method of claim 1, wherein the step of combining differences between the obtained values and the reference values takes account of weighting values associated with each of the reference values.

4. The method of claim 3, wherein the weighting values are statistically determined from values for the plurality of characteristics obtained for a plurality of reference embryos of known development potential.

5. The method of claim 4, wherein the weighting values are determined from a variance of the values obtained for the plurality of reference embryos.

6. The method of any preceding claim, wherein the plurality of characteristics relate to morphological developments of the embryo.

7. The method of claim 6, wherein the continuous variable represents a measure of regularity in the morphological developments of the embryo.

8. The method of claim 1, wherein the plurality of characteristics relate to temporal developments of the embryo.

9. The method of claim 8, wherein the continuous variable represents a measure of regularity in the temporal developments of the embryo.

10. The method of claim 1, wherein the plurality of characteristics comprise a plurality of cell cycle durations for the embryo, cci.

11. The method of claim 1, wherein the plurality of characteristics comprise a plurality of differences in time between subsequent cell divisions for the embryo, Δtj.

12. The method of claim 1, further comprising:
obtaining values for a further plurality of characteristics relating to the development of the embryo during the observation period;
determining a value for a further continuous variable by combining differences between the obtained values and corresponding reference values for the further plurality of characteristics in a further pre-defined manner; and
establishing the development potential for the embryo based also on the determined value for the further continuous variable.

13. A method according to claim 1, wherein the values are obtained by time-lapse microscopy.

14. An apparatus for determining a development potential for an embryo, the apparatus comprising:
a data input element configured to obtain values for a plurality of characteristics relating to the development of the embryo during an observation period; and
a processor element for determining a value for a continuous variable by combining differences between the obtained values and corresponding reference values for the plurality of characteristics in a pre-defined manner and establishing a development potential for the embryo based on the determined value for the continuous variable.

15. A non-transitory computer program product bearing machine readable instructions for carrying out the method of claim 1.

16. An apparatus loaded with and operable to execute machine readable instructions for carrying out the method of claim 1.
